(19) United States
(12) Patent Application Publication
(10) Pub. No.: US 2025/0321925 A1
(43) Pub. Date: Oct. 16, 2025

(54) METHODS OF DATA PRECIPITATION WITH DOCUMENT VARIATION ACROSS DISPARATE SEGMENTS OF COMPUTING INFRASTRUCTURE

(71) Applicant: Cloudburst Inc., Chino Valley, AZ (US)

(72) Inventor: Norman W. Freeman, Chino Valley, AZ (US)

(73) Assignee: Cloudburst Inc., Chino Valley, AZ (US)

(21) Appl. No.: 19/091,116

(22) Filed: Mar. 26, 2025

Related U.S. Application Data
(63) Continuation-in-part of application No. 18/635,650, filed on Apr. 15, 2024.

(51) Int. Cl. G06F 16/11

(52) U.S. Cl. CPC G06F 16/113; G06F 16/116

(57) ABSTRACT

Various methods, systems, and computer program products are provided for associating precipitated data. An example method includes receiving a first data packet. A first document is referenced in at least one data field of the first data packet. The method also includes determining at least one of a document type or a file path associated with the first document. The method further includes assigning the first document to a first document sub-folder of one or more document sub-folders. The assignment is based on the at least one of the document type or the file path of the first document. The method still further includes storing the first document in the first document sub-folder. Each of the one or more document sub-folders contains one or more document that have a same file path and are associated with the first identification record.

### CROSS-REFERENCE TO RELATED APPLICATION

This application is a continuation-in-part of U.S. Non-Provisional patent application Ser. No. 18/635,650 and titled “METHODS OF DATA PRECIPITATION ON DISPARATE SEGMENTS OF COMPUTING INFRASTRUCTURE.” The contents of the above application are incorporated by reference in their entirety.

### FIELD

An example embodiment relates generally to data formatting, and more particularly, to data precipitation on disparate segments of computing infrastructure.

### BACKGROUND

Currently, data stored in cloud systems or other third party system are often not stored in human interpretable, useful, and/or readable formats. Relational database systems store data in various locations that have cryptic, often numerical, relationships to one another. In an instance in which the data owner wanted to compile entity data housed within a cloud system without the use of the cloud vendor's native application, the entity would need access to the data tables and then the entity would have to tediously attempt to determine how the disparate data tables are related to one another to be able to retrieve all the data related to any single person or entity. As such, there exists a need for a system that can provide data precipitation on disparate segments of computing infrastructure.

### SUMMARY

The following paragraphs present a summary of various embodiments of the present disclosure and are merely examples of potential embodiments. As such, the summary is not meant to limit the subject matter or variations of various embodiments discussed herein.

In some aspects, the techniques described herein relate to a method for reformatting data, the method including: receiving one or more first data packets, wherein each of the one or more first data packets include one or more data fields for which a response is capable of being recorded, wherein each of the one or more first data packets are associated with a first identification record; converting each of the one or more first data packets into a readable textual format; generating a folder associated with the first identification record, wherein the folder associated with the first identification record includes at least one file associated with the first identification record; and storing the readable textual format of the one or more first data packets in the folder associated with the first identification record.

In some aspects, the techniques described herein relate to a method, further including sorting each of the one or more first data packets based on at least one data group, wherein the at least one data group is based on a data type.

In some aspects, the techniques described herein relate to a method, wherein sorting each of the one or more first data packets based on the at least one data group includes determining the at least one data group, wherein each of the at least one data group includes data relating to the first identification record.

In some aspects, the techniques described herein relate to a method, wherein sorting each of the one or more first data packets based on the at least one data group includes determining at least one data sub-group with the at least one data group, wherein each of the at least one data sub-group includes data relating to the first identification record.

In some aspects, the techniques described herein relate to a method, wherein each of the at least one file is associated with one of the at least one data group.

In some aspects, the techniques described herein relate to a method, further including causing a document associated with the first identification record to be stored in the folder associated with the first identification record.

In some aspects, the techniques described herein relate to a method, further including determining a folder name for the folder based on the first identification record.

In some aspects, the techniques described herein relate to a method, wherein the folder name for the folder based on the first identification record includes one or more unique alphanumerical characters based on the first identification record.

In some aspects, the techniques described herein relate to a method, further including causing the folder associated with the first identification record to be stored in a local or remote storage device.

In some aspects, the techniques described herein relate to a method, wherein the first identification record is determined via a first identification value.

In some aspects, the techniques described herein relate to a method, wherein the at least one file includes a detailed file, wherein the detailed file includes one or more data fields and a response for each of the one or more data fields, wherein the detailed file indicates an instance in which no response was provided for a given field of the one or more data fields.

In some aspects, the techniques described herein relate to a method, further including removing at least one of the one or more data fields based on a NULL response in the one or more first data packets.

In some aspects, the techniques described herein relate to a method, wherein the at least one file includes a summary file, wherein the summary file includes one or more data fields of the one or more first data packets and any responses to the one or more data fields of the one or more first data packets.

In some aspects, the techniques described herein relate to a method, wherein the at least one file includes a raw file, wherein the one or more first data packets associated with the first identification record are recorded as received in the raw file.

In some aspects, the techniques described herein relate to a method, further including: receiving one or more second data packets, wherein each of the one or more second data packets include one or more data fields for which a response is capable of being recorded, wherein each of the one or more second data packets are associated with a second identification record; generating a folder associated with the second identification record, wherein the folder associated with the second identification record includes at least one file associated with the second identification record; and storing the readable textual format of the one or more second data packets in the folder associated with the second identification record.

In some aspects, the techniques described herein relate to a method, wherein the folder associated with the first identification record and the folder associated with the second identification record are stored in an entity folder.

In some aspects, the techniques described herein relate to a method, wherein converting each of the one or more first data packets into the readable textual format includes determining the one or more data fields and one or more responses to the one or more data fields.

In some aspects, the techniques described herein relate to a method, wherein the at least one file includes a summary file, a detail file, and a raw file for each of the at least one data group.

In some aspects, the techniques described herein relate to a method, wherein the folder associated with the first identification record includes a document folder, wherein the document folder includes one or more documents associated with the first identification record.

In some aspects, the techniques described herein relate to a method, further including dividing data of the one or more first data packets based on the one or more data fields.

In some aspects, the techniques described herein relate to a method, wherein converting each of the one or more first data packets into the readable textual format may include removing at least one syntax value from the one or more first data packets.

In some aspects, the techniques described herein relate to a system for reformatting data, the system including: at least one non-transitory storage device; and at least one processing device coupled to the at least one non-transitory storage device, wherein the at least one processing device is configured to: receive one or more first data packets, wherein each of the one or more first data packets include one or more data fields for which a response is capable of being recorded, wherein each of the one or more first data packets are associated with a first identification record; convert each of the one or more first data packets into a readable textual format; generate a folder associated with the first identification record, wherein the folder associated with the first identification record includes at least one file associated with the first identification record; and store the readable textual format of the one or more first data packets in the folder associated with the first identification record.

In some aspects, the techniques described herein relate to a system, wherein the at least one processing device is further configured to sort each of the one or more first data packets based on at least one data group, wherein the at least one data group is based on a data type.

In some aspects, the techniques described herein relate to a system, wherein sorting each of the one or more first data packets based on the at least one data group includes determining the at least one data group, wherein each of the at least one data group includes data relating to the first identification record.

In some aspects, the techniques described herein relate to a system, wherein sorting each of the one or more first data packets based on the at least one data group includes determining at least one data sub-group with the at least one data group, wherein each of the at least one data sub-group includes data relating to the first identification record.

In some aspects, the techniques described herein relate to a system, wherein each of the at least one file is associated with one of the at least one data group.

In some aspects, the techniques described herein relate to a system, wherein the at least one processing device is further configured to cause a document associated with the first identification record to be stored in the folder associated with the first identification record.

In some aspects, the techniques described herein relate to a system, wherein the at least one processing device is further configured to determine a folder name for the folder based on the first identification record.

In some aspects, the techniques described herein relate to a system, wherein the folder name for the folder based on the first identification record includes one or more unique alphanumerical characters based on the first identification record.

In some aspects, the techniques described herein relate to a system, wherein the at least one processing device is further configured to cause the folder associated with the first identification record to be stored in a local or remote storage device.

In some aspects, the techniques described herein relate to a system, wherein the first identification record is determined via a first identification value.

In some aspects, the techniques described herein relate to a system, wherein the at least one file includes a detailed file, wherein the detailed file includes one or more data fields and a response for each of the one or more data fields, wherein the detailed file indicates an instance in which no response was provided for a given field of the one or more data fields.

In some aspects, the techniques described herein relate to a system, wherein the at least one processing device is further configured to remove at least one of the one or more data fields based on a NULL response in the one or more first data packets.

In some aspects, the techniques described herein relate to a system, wherein the at least one file includes a summary file, wherein the summary file includes one or more data fields of the one or more first data packets and any responses to the one or more data fields of the one or more first data packets.

In some aspects, the techniques described herein relate to a system, wherein the at least one file includes a raw file, wherein the one or more first data packets associated with the first identification record are recorded as received in the raw file.

In some aspects, the techniques described herein relate to a system, wherein the at least one processing device is further configured to: receive one or more second data packets, wherein each of the one or more second data packets include one or more data fields for which a response is capable of being recorded, wherein each of the one or more second data packets are associated with a second identification record; generate a folder associated with the second identification record, wherein the folder associated with the second identification record includes at least one file associated with the second identification record; and store the readable textual format of the one or more second data packets in the folder associated with the second identification record.

In some aspects, the techniques described herein relate to a system, wherein the folder associated with the first identification record and the folder associated with the second identification record are stored in an entity folder.

In some aspects, the techniques described herein relate to a system, wherein converting each of the one or more first data packets into the readable textual format includes determining the one or more data fields and one or more responses to the one or more data fields.

In some aspects, the techniques described herein relate to a system, wherein the at least one file includes a summary file, a detail file, and a raw file for each of the at least one data group.

In some aspects, the techniques described herein relate to a system, wherein the folder associated with the first identification record includes a document folder, wherein the document folder includes one or more documents associated with the first identification record.

In some aspects, the techniques described herein relate to a system, wherein the at least one processing device is further configured to divide data of the one or more first data packets based on the one or more data fields.

In some aspects, the techniques described herein relate to a system, wherein converting each of the one or more first data packets into the readable textual format may include removing at least one syntax value from the one or more first data packets.

In some aspects, the techniques described herein relate to a computer program product for reformatting data, the computer program product including at least one non-transitory computer-readable medium having one or more computer-readable program code portions embodied therein, the one or more computer-readable program code portions including at least one executable portion configured to: receive one or more first data packets, wherein each of the one or more first data packets include one or more data fields for which a response is capable of being recorded, wherein each of the one or more first data packets are associated with a first identification record; convert each of the one or more first data packets into a readable textual format; generate a folder associated with the first identification record, wherein the folder associated with the first identification record includes at least one file associated with the first identification record; and store the readable textual format of the one or more first data packets in the folder associated with the first identification record.

In some aspects, the techniques described herein relate to a computer program product, wherein the one or more computer-readable program code portions include at least one executable portion further configured to sort each of the one or more first data packets based on at least one data group, wherein the at least one data group is based on a data type.

In some aspects, the techniques described herein relate to a computer program product, wherein sorting each of the one or more first data packets based on the at least one data group includes determining the at least one data group, wherein each of the at least one data group includes data relating to the first identification record.

In some aspects, the techniques described herein relate to a computer program product, wherein sorting each of the one or more first data packets based on the at least one data group includes determining at least one data sub-group with the at least one data group, wherein each of the at least one data sub-group includes data relating to the first identification record.

In some aspects, the techniques described herein relate to a computer program product, wherein each of the at least one file is associated with one of the at least one data group.

In some aspects, the techniques described herein relate to a computer program product, wherein the one or more computer-readable program code portions include at least one executable portion further configured to cause a document associated with the first identification record to be stored in the folder associated with the first identification record.

In some aspects, the techniques described herein relate to a computer program product, wherein the one or more computer-readable program code portions include at least one executable portion further configured to determine a folder name for the folder based on the first identification record.

In some aspects, the techniques described herein relate to a computer program product, wherein the folder name for the folder based on the first identification record includes one or more unique alphanumerical characters based on the first identification record.

In some aspects, the techniques described herein relate to a computer program product, wherein the one or more computer-readable program code portions include at least one executable portion further configured to cause the folder associated with the first identification record to be stored in a local or remote storage device.

In some aspects, the techniques described herein relate to a computer program product, wherein the first identification record is determined via a first identification value.

In some aspects, the techniques described herein relate to a computer program product, wherein the at least one file includes a detailed file, wherein the detailed file includes one or more data fields and a response for each of the one or more data fields, wherein the detailed file indicates an instance in which no response was provided for a given field of the one or more data fields.

In some aspects, the techniques described herein relate to a computer program product, wherein the one or more computer-readable program code portions include at least one executable portion further configured to remove at least one of the one or more data fields based on a NULL response in the one or more first data packets.

In some aspects, the techniques described herein relate to a computer program product, wherein the at least one file includes a summary file, wherein the summary file includes one or more data fields of the one or more first data packets and any responses to the one or more data fields of the one or more first data packets.

In some aspects, the techniques described herein relate to a computer program product, wherein the at least one file includes a raw file, wherein the one or more first data packets associated with the first identification record are recorded as received in the raw file.

In some aspects, the techniques described herein relate to a computer program product, wherein the one or more computer-readable program code portions include at least one executable portion further configured to: receive one or more second data packets, wherein each of the one or more second data packets include one or more data fields for which a response is capable of being recorded, wherein each of the one or more second data packets are associated with a second identification record; generate a folder associated with the second identification record, wherein the folder associated with the second identification record includes at least one file associated with the second identification record; and store the readable textual format of the one or more second data packets in the folder associated with the second identification record.

In some aspects, the techniques described herein relate to a computer program product, wherein the folder associated with the first identification record and the folder associated with the second identification record are stored in an entity folder.

In some aspects, the techniques described herein relate to a computer program product, wherein converting each of the one or more first data packets into the readable textual format includes determining the one or more data fields and one or more responses to the one or more data fields.

In some aspects, the techniques described herein relate to a computer program product, wherein the at least one file includes a summary file, a detail file, and a raw file for each of the at least one data group.

In some aspects, the techniques described herein relate to a computer program product, wherein the folder associated with the first identification record includes a document folder, wherein the document folder includes one or more documents associated with the first identification record.

In some aspects, the techniques described herein relate to a computer program product, wherein the one or more computer-readable program code portions include at least one executable portion further configured to divide data of the one or more first data packets based on the one or more data fields.

In some aspects, the techniques described herein relate to a computer program product, wherein converting each of the one or more first data packets into the readable textual format may include removing at least one syntax value from the one or more first data packets.

In some aspects, the techniques described herein relate to a method for associating precipitated data, the method including: receiving a first data packet, wherein a first document is referenced in at least one data field of the first data packet, and wherein the first data packet and the first document are associated with a first identification record; determining at least one of a document type or a file path associated with the first document; assigning the first document to a first document sub-folder of one or more document sub-folders, wherein the assignment is based on the at least one of the document type or the file path of the first document; and storing the first document in the first document sub-folder, wherein each of the one or more document sub-folders contains one or more document that have a same file path and are associated with the first identification record.

In some aspects, the techniques described herein relate to a method, further including converting the first data packet into a readable textual format, wherein the readable textual format includes reference to the first document sub-folder in the at least one data field that references the first document.

In some aspects, the techniques described herein relate to a method, wherein the readable textual format of the first data packet is stored as at least one of a detailed file or a summary file, wherein the at least one of the detailed file or the summary file references the first document sub-folder.

In some aspects, the techniques described herein relate to a method, wherein the at least one of the detailed file or the summary file includes a hyperlink to the first document stored in the first document sub-folder.

In some aspects, the techniques described herein relate to a method, wherein the first document sub-folder is stored within a folder associated with the first identification record.

In some aspects, the techniques described herein relate to a method, wherein the first data packet references one or more additional documents in the at least data field, wherein each of the one or more additional documents are assigned to one of the one or more document sub-folders.

In some aspects, the techniques described herein relate to a method, wherein determining the file path of the first document is based on an API endpoint from which the first document is received.

In some aspects, the techniques described herein relate to a method, wherein each of the one or more documents sub-folders are stored within a folder associated with the first identification record.

In some aspects, the techniques described herein relate to a method, wherein the folder associated with the first identification record is based on the first identification record.

In some aspects, the techniques described herein relate to a method, further including generating metadata associated with the file path for the first document.

In some aspects, the techniques described herein relate to a system for associating precipitated data, the system including: at least one non-transitory storage device; and at least one processing device coupled to the at least one non-transitory storage device, wherein the at least one processing device is configured to: receive a first data packet, wherein a first document is referenced in at least one data field of the first data packet, and wherein the first data packet and the first document are associated with a first identification record; determine at least one of a document type or a file path associated with the first document; assign the first document to a first document sub-folder of one or more document sub-folders, wherein the assignment is based on the at least one of the document type or the file path of the first document; and store the first document in the first document sub-folder, wherein each of the one or more document sub-folders contains one or more document that have a same file path and are associated with the first identification record.

In some aspects, the techniques described herein relate to a system, wherein the at least one processing device is further configured to convert the first data packet into a readable textual format, wherein the readable textual format includes reference to the first document sub-folder in the at least one data field that references the first document.

In some aspects, the techniques described herein relate to a system, wherein the readable textual format of the first data packet is stored as at least one of a detailed file or a summary file, wherein the at least one of the detailed file or the summary file references the first document sub-folder.

In some aspects, the techniques described herein relate to a system, wherein the at least one of the detailed file or the summary file includes a hyperlink to the first document stored in the first document sub-folder.

In some aspects, the techniques described herein relate to a system, wherein the first document sub-folder is stored within a folder associated with the first identification record.

In some aspects, the techniques described herein relate to a system, wherein the first data packet references one or more additional documents in the at least data field, wherein each of the one or more additional documents are assigned to one of the one or more document sub-folders.

In some aspects, the techniques described herein relate to a system, wherein determining the file path of the first document is based on an API endpoint from which the first document is received.

In some aspects, the techniques described herein relate to a system, wherein each of the one or more documents sub-folders are stored within a folder associated with the first identification record.

In some aspects, the techniques described herein relate to a system, wherein the folder associated with the first identification record is based on the first identification record.

In some aspects, the techniques described herein relate to a system, wherein the at least one processing device is further configured to generate metadata associated with the file path for the first document.

In some aspects, the techniques described herein relate to a computer program product for associating precipitated data, the computer program product including at least one non-transitory computer-readable medium having one or more computer-readable program code portions embodied therein, the one or more computer-readable program code portions including at least one executable portion configured to: receive a first data packet, wherein a first document is referenced in at least one data field of the first data packet, and wherein the first data packet and the first document are associated with a first identification record; determine at least one of a document type or a file path associated with the first document; assign the first document to a first document sub-folder of one or more document sub-folders, wherein the assignment is based on the at least one of the document type or the file path of the first document; and store the first document in the first document sub-folder, wherein each of the one or more document sub-folders contains one or more document that have a same file path and are associated with the first identification record.

In some aspects, the techniques described herein relate to a computer program product, wherein the one or more computer-readable program code portions include at least one executable portion further configured to convert the first data packet into a readable textual format, wherein the readable textual format includes reference to the first document sub-folder in the at least one data field that references the first document.

In some aspects, the techniques described herein relate to a computer program product, wherein the readable textual format of the first data packet is stored as at least one of a detailed file or a summary file, wherein the at least one of the detailed file or the summary file references the first document sub-folder.

In some aspects, the techniques described herein relate to a computer program product, wherein the at least one of the detailed file or the summary file includes a hyperlink to the first document stored in the first document sub-folder.

In some aspects, the techniques described herein relate to a computer program product, wherein the first document sub-folder is stored within a folder associated with the first identification record.

In some aspects, the techniques described herein relate to a computer program product, wherein the first data packet references one or more additional documents in the at least data field, wherein each of the one or more additional documents are assigned to one of the one or more document sub-folders.

In some aspects, the techniques described herein relate to a computer program product, wherein determining the file path of the first document is based on an API endpoint from which the first document is received.

In some aspects, the techniques described herein relate to a computer program product, wherein each of the one or more documents sub-folders are stored within a folder associated with the first identification record.

In some aspects, the techniques described herein relate to a computer program product, wherein the folder associated with the first identification record is based on the first identification record.

In some aspects, the techniques described herein relate to a computer program product, wherein the one or more computer-readable program code portions include at least one executable portion further configured to generate metadata associated with the file path for the first document.

### BRIEF DESCRIPTION OF THE DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and embodiments are merely illustrative of the principles of the present disclosure. Therefore, in the drawings:

FIG. 1 provides a block diagram illustrating a system environment for data precipitation on disparate segments of computing infrastructure, in accordance with various embodiments of the present disclosure;

FIG. 2 provides a block diagram illustrating the data management server(s) 151 of FIG. 1, in accordance with various embodiments of the present disclosure;

FIG. 3 provides a block diagram illustrating the computing device(s) 152 of FIG. 1, in accordance with various embodiments of the present disclosure;

FIG. 4 provides a flowchart 400 illustrating the high-level structure to be processed as discussed herein, such as the operations of FIGS. 5A, 5B, and 10, in accordance with various embodiments of the present disclosure;

FIGS. 5A and 5B illustrate a detailed flow diagram 500 of the flowchart 400 shown in FIG. 4, in accordance with various embodiments of the present disclosure;

FIG. 6A illustrates an example raw file generated for a data group using operations discussed herein, in accordance with various embodiments of the present disclosure;

FIG. 6B illustrates an example detailed file generated for a data group using operations discussed herein, in accordance with various embodiments of the present disclosure;

FIG. 6C illustrates an example summary file generated for a data group using operations discussed herein, in accordance with various embodiments of the present disclosure;

FIG. 7 illustrates an example file structure in which each identification record is provided an individual folder to contain the files generated using various operations herein, in accordance with various embodiments of the present disclosure;

FIG. 8 illustrates the contents of a folder associated with a given identification record generated using various operations herein, in accordance with various embodiments of the present disclosure;

FIG. 9 illustrates an example documents folder containing documents associated with the given identification record, in accordance with various embodiments of the present disclosure;

FIG. 10 is a flowchart illustrating a method of reformatting data, in accordance with various embodiments of the present disclosure;

FIGS. 11A and 11B illustrate an example flow diagram of the implementation of the operations discussed herein, such as the flow diagram 500 show in FIGS. 5A and 5B, in accordance with various embodiments of the present disclosure;

FIG. 12 is a flowchart illustrating sorting files precipitated based on file path, in accordance with various embodiments of the present disclosure; and

FIG. 13 is a flowchart illustrating additional operations relating to sorting files precipitated based on file path, in accordance with various embodiments of the present disclosure.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements.

Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Throughout this specification and the claims, the terms “comprise,” “comprises”, and “comprising” are used in a non-exclusive sense, except where the context requires otherwise. Likewise, the term “includes” and its grammatical variants are intended to be non-limiting, such that recitation of items in a list is not to the exclusion of other like items that can be substituted or added to the listed items.

### I. Example Use Cases

Companies, organizations, persons, or other entities (“entity or entities”) often have data regarding customers, clients, assets, finances, persons, objects, processes, and/or things that the entity would like to organize, process, store, and retrieve. Collectively, such data may be referred to as entity data. In an instance in which an entity uses a third party data management system (e.g., a cloud-based software vendor), the entity may not be privy to the data management system. In other words, the entity may not know the database architecture and/or data relationships developed by the third party (e.g., the cloud-based software vendor). Rather, the entity relies upon the front-end interface of the third party data management system to view and manipulate the entity data. Many of these third party data management system provide an open Application Programming Interface (API) to provide access to the entity data. For example, the third party vendor may require that the entity back up the entity data and/or disclaim liability for loss or damage to entity data. Furthermore, in an instance in which the vendor defaults and/or in an instance in which the entity's relationship with the vendor is terminated, the entity no longer has access to the entity data nor the front-end interface to access the entity data. As such, the entity may only be able to obtain the entity data in the format used by the third party data management system, which provides little to no utility to the entity.

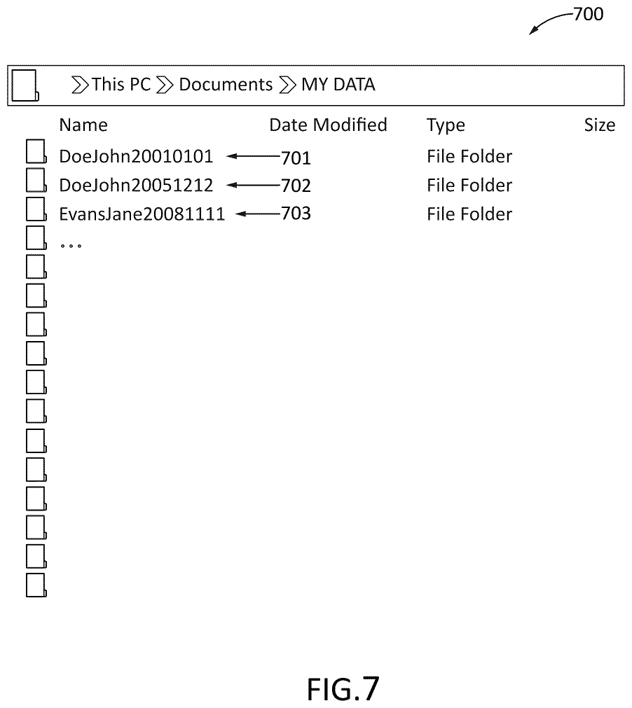

Various embodiments of the present disclosure allow for the entity data provided by a third party (e.g., a vendor) to be processed for use by the entity. Various embodiments herein identify entity data, related data, and any available metadata belonging to each of the identification records (e.g., the entity's customers) in all areas of the database. Identified entity data may be parsed to convert API syntax to human readable text, then sorted, combined, and written to various files that are organized in a structure that can be used by the entity without the use of the front-end interface of the third party data management system. File storage paths will be named by further parsing the identification record (e.g., a customer's name) to remove any characters or punctuation that are not compatible with file naming conventions in the preferred operation system(s) (e.g., UNIX, LINUX, Windows, Apple and/or Android operating systems). One or more unique alphanumerical characters will be appended to the name so that the entity may distinguish between two sets of entity data that have the same name. For example, the customer's birthdate may be appended to the name in the folder name. The entity would then be able to distinguish between two customers who are both named John Doe. The example shown in FIGS. 7-9 illustrate a Windows file system, however the files can be written to local or remote storage devices including removable temporary storage devices such as flash, USB, or thumb drives, Network Accessible Storage devices, ftp or third-party file sharing systems.

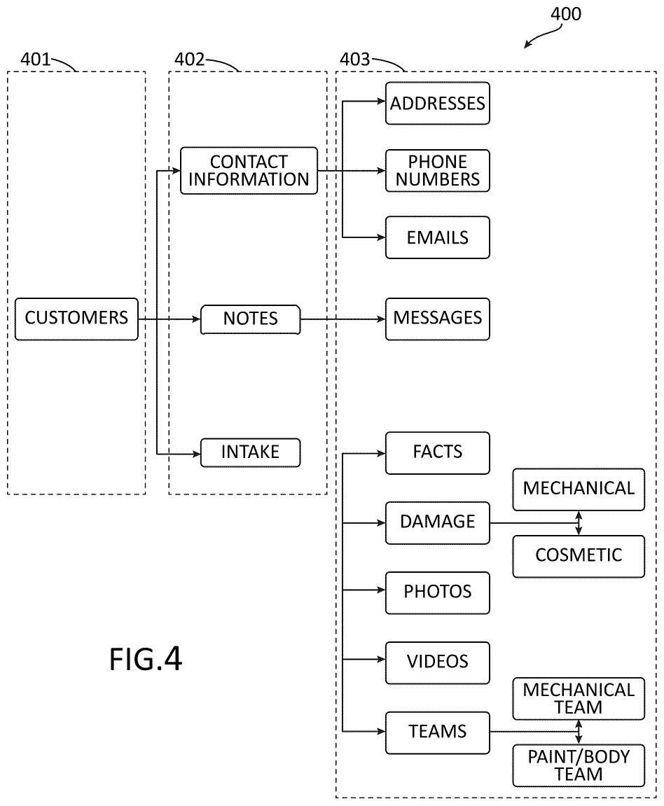

More specifically, Data Groups and Data Sub-Groups will be identified. In an example embodiment in which the identification records are associated with individual customers (e.g. FIG. 4), the process may determine customer data located in the Data Group “Contact Information,” then it would find the customer data located in the Contact Information Sub-Groups “Addresses,” “Phone Numbers,” and “Emails.” The data identified will be sorted and written to files within the folder associated with the given identification record (e.g., the given customer) and named to represent and make human readable the type of data the file contains. For example, the Data Group related to Contact Information of the customer will be written to files whose name will start with “Contact.” After the data from Data Group “Contact Information” and any related Sub-Groups is identified, sorted, and written to the appropriate files, the process will repeat with the next Data Group, in the example shown in FIG. 4, that would be “Notes” and its Sub-Group, “Messages.”

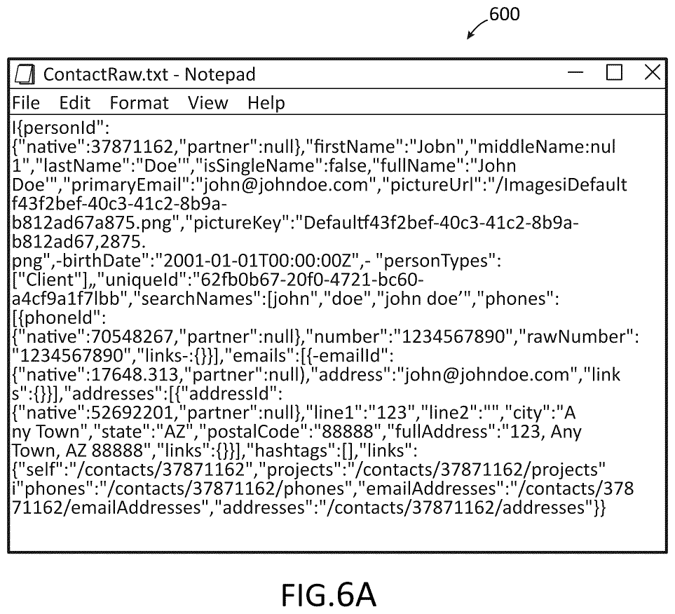

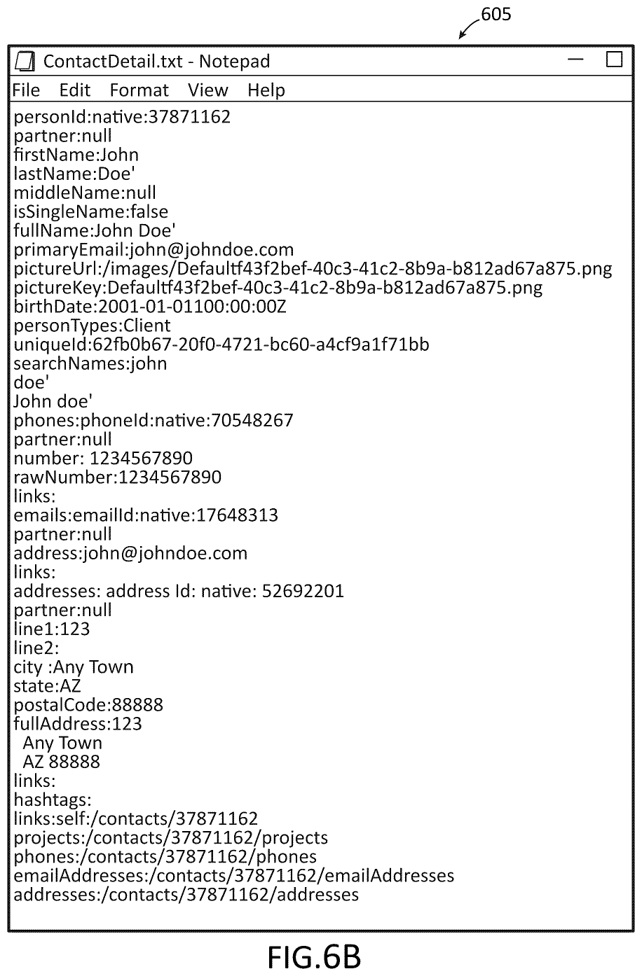

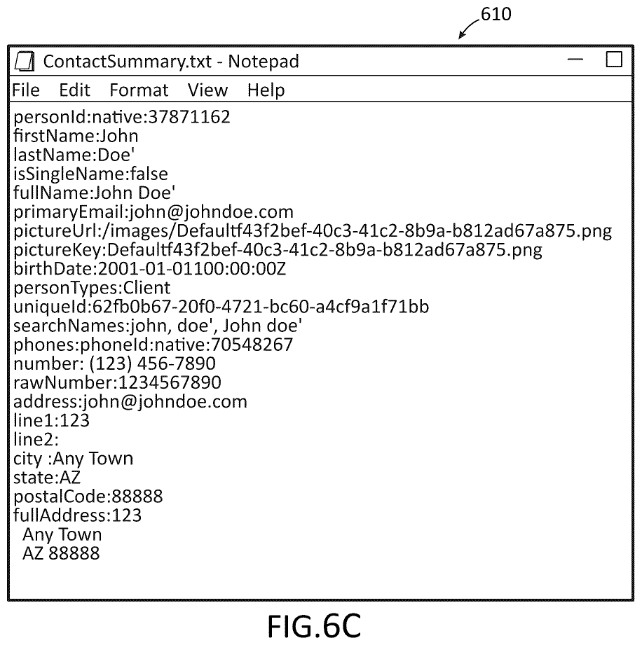

In various embodiments, the system may generate three unique files for each Data Group. The files may include a detailed file (e.g., ContactDetail.txt shown in FIG. 6B). The detailed file may be used to store all data related to the precipitated Contact information even if the response to a data field is NULL. The detailed file shows all fields, including those with NULL or blank values. The detailed file may be helpful when auditing the data from within a system. For instance, the entity would know that a field existed and was intentionally left blank.

Another example file type includes a summary file (e.g., ContactSummary.txt shown in FIG. 6C). The summary file may include data fields and responds for which the responses do not have “null” in the data field. The pared down nature of the summary file with null fields deleted may be helpful when the entity just wants to quickly identify, view, or manipulate data without having to sort through unpopulated data fields or null values.

A third example file type is a raw file (e.g., ContactRaw.txt shown in FIG. 6A). The raw file may contain the complete data object that was returned from the API call without any parsing, filtering, or processing. The raw file preserves all available information. The raw file may be particularly useful should the entity wish to migrate the data to another system. The raw file may include a JSON string of values that are parsed, filtered, and/or sorted as discussed herein to generate the detailed file(s) and/or the summary file(s).

In various embodiments, a set of three similarly named files (e.g., a detailed file, a summary file, and a raw file) will be created for each data group to make it easy for a non-technical human to interpret what type of information is available in each file. After all the individual files have been populated, the system will search for and locate any documents related to the identification record (e.g., related to the person or entity). Such documents represent files that were loaded into the system as documents. Examples are Word Documents, PDF files, JPG images, and/or any other standard document format wherein the object is stored as it was created. An automated process will locate these documents and then name them based on the original document title before storing them in a document folder (e.g., a sub-folder named \Docs). For example, any documents related to John Doe may be stored in C:\DocJohn20010101\Docs. The process for customer John Doe will end when all data groups and data sub-groups have been exhausted and all customer data has been written to the files and folders described. The process then repeats for the next identification record (e.g., next customer or data entity). When data from all of the data groups and data sub-groups of all identification records have been precipitated, the process terminates and awaits a trigger event such as a timer to begin again.

In various embodiments, systems and/or computer program products may be provided configured to carry out the operations of the method discussed herein.

Modern databases store binary representations of documents or other files that are loaded into the database. Databases may also store data related to the file, such as the path of a subfolder, location that the file is stored (e.g., physical and/or virtual location), and/or the like. Database(s) may include information about the files name and the type of file (e.g., text file, word document, pdf, excel, jpeg, mp4, etc.). In some cases, file paths are added as part of the storage scheme or by the user. File paths may be important to preserve the organizational structure of the files in an instance in which the files are precipitated out of the database, in order to make the files human usable without the CRM/CMS system. However, unless the file paths are added, there is no way to determine the file path for files that is precipitated out of the database. Therefore, there exists a need to retrieve more information relating to files that are precipitated.

Various embodiments of the present disclosure allow for the data being precipitated to be tracked and/or otherwise monitored for information during precipitation. To do this, a method is provided to replicate file path for file(s). File paths may be stored in metadata, a separate system file, or in a data stream associated with the operating system. In each instance attributes of the file path may be accessible by only system level resources, thus the file architecture may be hidden from users or the API call. Therefore, the file path may be replicated based on various factors, such as document name, document type, document contents, portions of the file path, and/or the like. In some aspects, document contents may be tokenized and referenced to assemble like documents that may belong to a corpus at a given file path. In others, the portions of the file path or document type or name may provide association with a given file path. Further, in various embodiments, the file paths for a file may be stored along with the file (e.g., as the file title and/or as metadata related to the file). Additionally or alternatively, the file path may determine the location that the given file is stored. For example, the file path may assist the system determining a storage location for a given file. In various embodiments, files with similar or the same file path may be stored together and/or otherwise grouped together.

The file path may be used in connection with the naming conventions discussed herein. For example, the file path may be used to determine a storage location for a file associated with a first identification record. In such an instance, the file may have a document name matching the various embodiments discussed herein. In various embodiments, the files may be sorted into sub-grouped based on the file path. For example, the file may be stored in sub-folders based on file path (e.g., based on previous storage location on the database from which the data was precipitated, document type, document name, and/or the like).

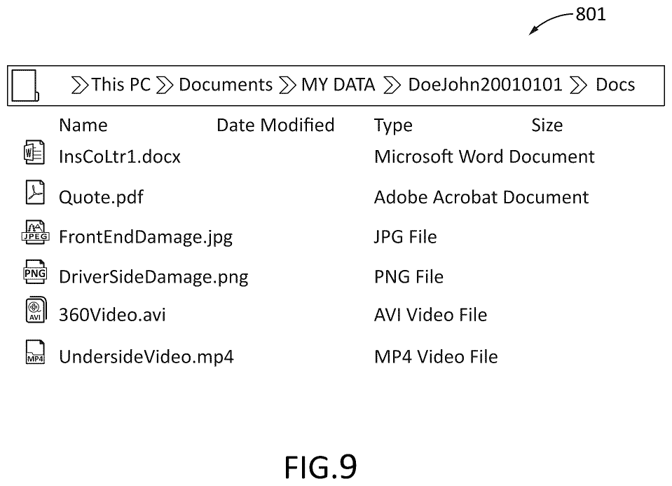

In various embodiments, the one or more data packets (e.g., first data packet(s)) may include one or more files (e.g., documents discussed herein, such as the documents shown in FIG. 9). In various embodiments, the system may separate the files based on the associated identification record. For example, as shown in FIG. 9, files associated with John Doe are stored in a folder. Various types of documents (e.g., .docx, .pdf, .jpg, .png, .avi, .mp4, etc.) may be stored and associated with a given identification record.

Various embodiments of the present disclosure allow for file paths associated with the documents to be determined (e.g., replicated) and the documents sorted using the file paths. For example, the documents in the “Docs” folder of FIG. 9 may be further sorted into sub-folders based on the file path. In various embodiments, the sub-folders may be based on document type (e.g., each file of a certain document type may be assigned to the same sub-folder). The sub-folder location may be based on other file path information, such as document origin, document usage, and/or the like.

In various embodiments, the file path may also be based on the API endpoints discussed herein. For example, the API endpoint(s) and/or the API call(s) may indicate the data being precipitated and the file path for files may be based on the API endpoints. For example, each file in a data packet received via an API endpoint may be grouped with the same or similar file path. In various embodiments, the document type may also affect the file path. For example, each document type from the same API endpoint may be grouped together in a sub-group. In various embodiments, the document type may indicate the type of file based on the API endpoint. For example, a database that includes information may use specific data types for different operations. In such an example, the system may identify the file path based on the API endpoint and the document type (e.g., all .pdf files received via a given API endpoint may be associated with the same operations and may be stored together in a sub-folder).

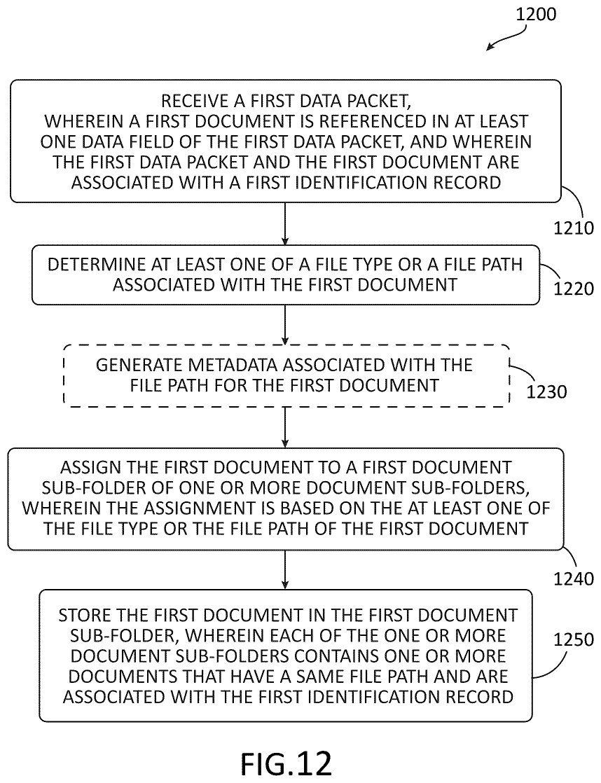

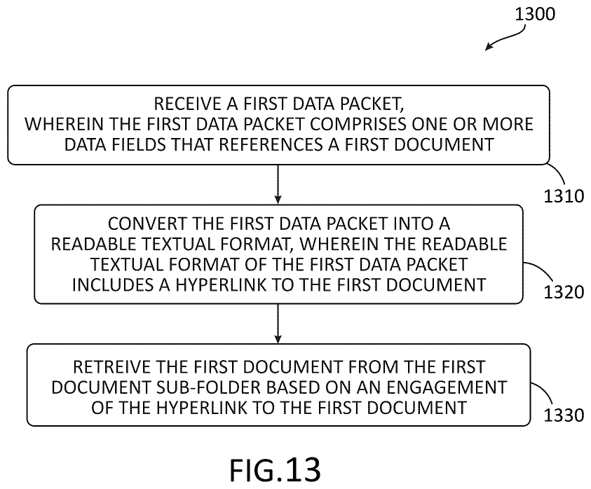

In various embodiments, the documents associated with data precipitation (e.g., a document referenced in a raw file during data precipitation) may be received by the system. The system of various embodiments allows the documents received to be connected and/or stored in a way that the documents may be properly used (e.g., upon engagement of the files by a user). As such, the files discussed herein (e.g., raw file, detailed file, summary file, etc.) may include information relating to a document. For example, a raw file may include reference to the document. The system may be able to determine the file path of the document based on the files (e.g., based on the raw file) and update the detailed file and/or the summary file to have reference the document (e.g., the storage location of the document, the document name, etc.). In various embodiments, the readable textual format of the detailed file and/or the summary file may include the document name, document type, file path, and/or the like to allow a user to identify the document. More information and operations are discussed in reference to FIGS. 12 and 13. In various embodiments, any of the operations discussed herein may be carried out in conjunction with the operations of FIGS. 12 and/or 13.

### II. With Reference to the FIGs

Reference will now be made in detail to aspects of the disclosure, examples of which are illustrated in the accompanying drawings. The following description refers to the accompanying drawings in which the same numbers in different drawings represent the same or similar elements unless otherwise represented. The implementations set forth in the following description do not represent all implementations consistent with the disclosure. Instead, they are merely examples of apparatuses and methods consistent with aspects related to the disclosure as recited in the appended claims. Particular aspects of the present disclosure are described in greater detail below. The terms and definitions provided herein control, if in conflict with terms and/or definitions incorporated by reference.

Systems, methods, and apparatuses are described herein which relate generally to data precipitation on disparate segments of computing infrastructure. In the following description, for purposes of explanation, numerous specific details are set forth to provide a thorough understanding of the present disclosure. It will be evident, however, to one skilled in the art that the present disclosure may be practiced without these specific details and/or with any combination of these details.

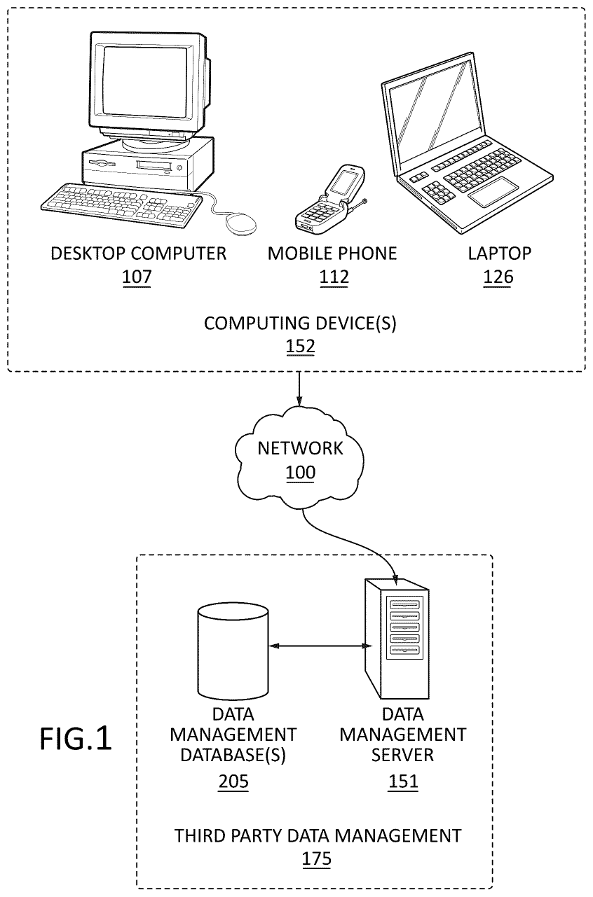

Referring now to FIG. 1, a block diagram illustrating a system environment (“system”) for data precipitation on disparate segments of computing infrastructure, in accordance with various embodiments is provided. The system includes computing device(s) 152 and a third party data management system 175 connected to a network 100. As shown, the computing device(s) 152 (e.g., desktop computer 107, mobile phone 112, laptop 126, and/or the like) associated with users are in communication with network 100. The third party data management system 175 is also in communication with the network 100. The third party data management system 175 includes one or more data management servers 151 and one or more data management databases 205. In various embodiments, the data management server(s) 151 may be made of multiple servers. In various embodiments, the data management database(s) 205 may be part of the data management server(s) 151 (e.g., at least a portion of the data management database(s) 205 may be stored on the memory device(s) 268 of the data management server(s) 151). Additionally or alternatively, at least a portion of the data management database(s) 205 may be stored remote from the data management server(s) 151.

The data management database(s) 205 may be part or, or in communication with the third party data management system 175. The data management database(s) 205 may include entity data for one or more entities. The data management database(s) 205 may include the entity data across multiple entities (e.g., a vendor may store and/or provide entity data for multiple entities). The format of the entity data stored on the data management database(s) 205 may be based on the front-end interface of the data management server(s) 151. For example, the front-end interface of the data management server(s) 151 may be a customer portal that allows for the entity to access the entity data. As such, the raw data stored on the data management database(s) 205 may be formatted with syntax to be processed and displayed by the data management server(s) 151. In various embodiments, the entities may have access to entity data associated with the given entity via an API. The API may allow the entity data to be retrieved from the data management database(s) 205.

In various embodiments, database(s) in the environment may include API endpoint database(s) that contain information relating to the previous API calls. For example, an API call may include one or more API endpoints collected. The API endpoints may be used to determine endpoints in subsequent API call(s). For example, the API endpoints used to retrieve entity data for a first entity on a third party data management system may be the same or similar to the API endpoints used to retrieve entity data for a second entity on the third party data management system. The API endpoints retrieved from previous API calls may be stored and/or sorted, such that the system may be used to automatically load the endpoints necessary to retrieve the entity data for subsequent entities.

The API endpoint database may be part of another database in the environment (e.g., part of the data management database(s) 205 and/or one or more databases stored on a computing device(s) 152). In various embodiments, the API endpoint database may be stored at least partially on the third party data management system 175 and/or the computing device(s) 152. As such, the system is capable of using previous processes to assist in subsequent processes. For example, the retrieval of entity data may be expedited due to the data stored on the API endpoint database(s). in various embodiments, the API endpoint database(s) and/or any other database(s) discussed herein may be stored remote from the computing device(s) 152 and/or the third party data management system 175. For example, at least a portion of the API endpoint database(s) may be stored on a cloud based server in which the computing device(s) 152 have access. As such, the system environment may include one or more databases that are stored remotely (e.g., a cloud server) and are accessible by computing device(s) 152.

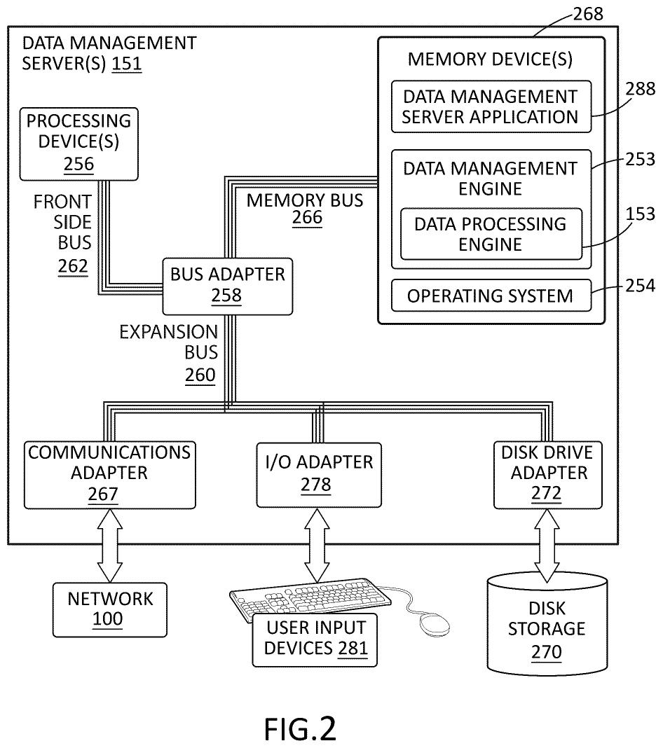

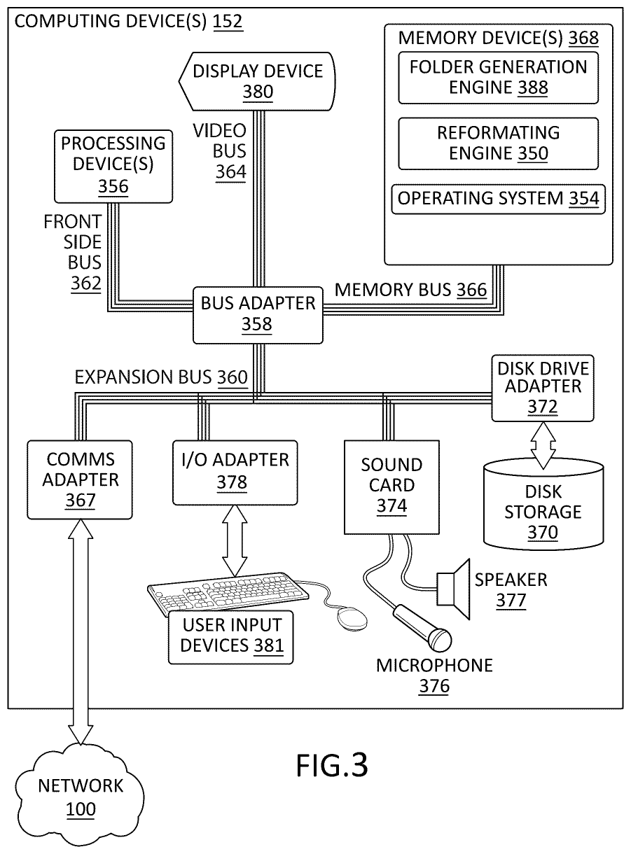

Referring now to FIG. 2, a block diagram illustrating the data management server(s) 151 of FIG. 1, in accordance with various embodiments is provided. FIG. 2 is merely illustrative an example data management server(s) 151. In various embodiments, the data management server(s) 151 may share components with the computing device(s) 152 (e.g., the data management server(s) 151 may use at least a portion of the processing device(s) 356 of the computing device(s) 152 shown in FIG. 3). The data management server(s) 151 may be comprised of one or more servers. In various embodiments, the data management server(s) 151 may be capable of processing user inputs via a computing device(s) 152 and generating user interfaces to be rendered to computing device(s) 152.

The data management server(s) 151 of FIG. 2 includes one or more processing devices 256 and one or more memory devices 268, communication adapter 267, an input/output adapter 278, and a disk drive adapter 272. In various embodiments, the various components may be connected to one another via a BUS adapter 258 (e.g., the processing device(s) 256 may be attached via a front side BUS 262, the memory device(s) 268 may be attached via a memory BUS 266, and the communication adapter 267, I/O adapter 278, disk drive adapter 272, and/or other interfaces may be attached via expansion BUS 260).

It should be understood that the memory device(s) 268 may include one or more databases or other data structures/repositories. The memory device(s) 268 also includes computer-executable program code that instructs the processing device(s) 256 to operate the network communication interface (e.g., communication adapter 267) to perform certain communication functions of the system described herein. For example, in one embodiment of the data management server(s) 151, the memory device(s) 268 includes, but is not limited to, a data management server application 288, a data management engine 253, and an operating system 254. The data management engine 253 may also include a data processing engine 153, and/or the like with instructions to carry out the processing of the entity data. The data management engine 253 may have various other components that are capable of processing user inputs via a computing device(s) 152.

Some embodiments of the data management server(s) 151 include processing device(s) 256 communicably coupled to such components as the memory device(s) 268, the communication adapter 267, the input/output adapter 278, the disk drive adapter 272, and/or the like. The processing device(s) 256, and other processors described herein, generally include circuitry for implementing communication and/or logic functions of the system. For example, the processing device(s) 256 may include a digital signal processor device, a microprocessor device, and various analog to digital converters, digital to analog converters, and/or other support circuits. Control and signal processing functions of the data management server(s) 151 are allocated between these devices according to their respective capabilities. The processing device(s) 256 thus may also include the functionality to encode and interleave messages and data prior to modulation and transmission. The processing device(s) 256 can additionally include an internal data modem. Further, the processing device(s) 256 may include functionality to operate one or more software programs, which may be stored in the memory device(s) 268. For example, the processing device(s) 256 may be capable of operating a connectivity program to communicate via the communication adapter 267.

The processing device(s) 256 is configured to connect to the network 100 via the communication adapter 267 to communicate with one or more other devices on the network 100. In this regard, the communication adapter 267 may include various components, such as an antenna operatively coupled to a transmitter and a receiver (together a “transceiver”). The processing device(s) 256 is configured to provide signals to and receive signals from the transmitter and receiver, respectively. The signals may include signaling information in accordance with the air interface standard of the applicable cellular system of the network 100. In this regard, the data management server(s) 151 may be configured to operate with one or more air interface standards, communication protocols, modulation types, and access types. By way of illustration, the data management server(s) 151 may be configured to operate in accordance with any of a number of first, second, third, fourth, and/or fifth-generation communication protocols and/or the like. In various embodiments, the data management server(s) 151 may also be connected via other connection methods to one or more components of the third party data management system 175.

The I/O adapter 278, which allow the data management server(s) 151 to receive data from a user such as a system administrator, may include any of a number of devices allowing the data management server(s) 151 to receive data from the user, such as a keypad, keyboard 281, touch-screen, touchpad, microphone, mouse, joystick, other pointer device, button, soft key, and/or other input device(s). The user interface may also include a camera, such as a digital camera.

The disk drive adapter 272 may provide additional storage space via disk storage 270. Various other storage mediums may also be used by the data management server(s) 151, such as cloud storage (e.g., transmitted via the communication adapter 267).

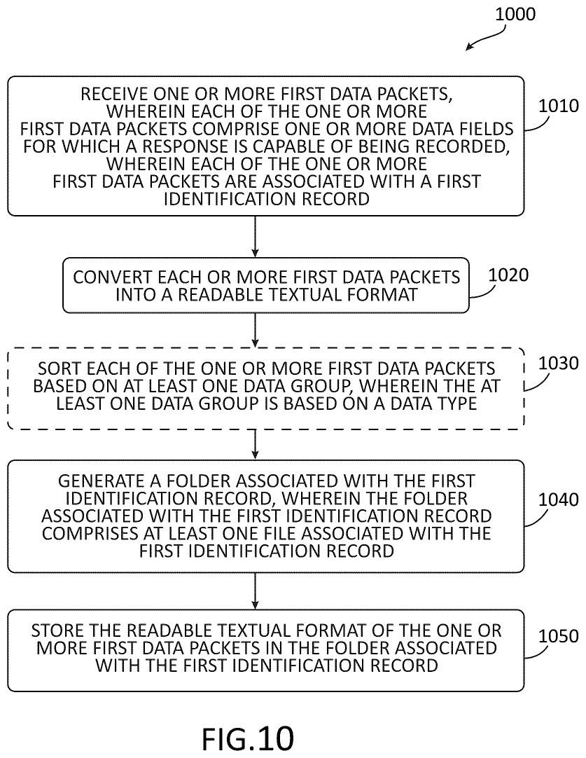

Referring now to FIG. 3, a block diagram illustrating the computing device(s) 152 of FIG. 1, in accordance with various embodiments is provided. FIG. 3 is merely illustrative an example computing device(s) 152. Various types of computing device(s) 152 may be used or otherwise contemplated for the system. The computing device(s) 152 may be any computing device that is used to process the entity data as discussed herein (e.g., the flowchart 1000 of FIG. 10) and/or view the processed data (e.g., as shown in FIGS. 6A-9).

Example computing devices include desktop computers 107, mobile devices, such as mobile phones 112, tablets, smart watches, etc., laptops 126, and/or the like. As such, the computing device(s) 152 may be any device that is capable of performing the operations discussed herein. For example, a mobile phone may include communication interfaces to communication with mobile networks and local area networks (e.g., via Wi-Fi).

The computing device(s) 152 of FIG. 3 includes one or more processing devices 356, one or more memory devices 368, a display device 380, a communication adapter 367, an input/output adapter 378, and a disk drive adapter 372. In various embodiments, the various components may be connected to one another via a BUS adapter 358 (e.g., the processing device(s) 356 may be attached via a front side BUS 362, the memory device(s) 368 may be attached via a memory BUS 366, the display device 380 may be attached via a video BUS 364, and the communication adapter 367, I/O adapter 378, disk drive adapter 372, and/or other interfaces may be attached via expansion BUS 360).

It should be understood that the memory device(s) 368 may include one or more databases or other data structures/repositories. The memory device(s) 368 also includes computer-executable program code that instructs the processing device(s) 356 to operate the network communication interface (e.g., communication adapter 367) to perform certain communication functions of the system described herein. The memory device(s) 368 may include a folder generation engine 388 with instructions on generating and/or naming the folders associated with various identification records. The memory device(s) 368 also includes a reformatting engine 350 that includes instructions on reformatting the raw data received from a third party data management system 175 as discussed herein. The memory device(s) 368 may also include the operating system 354 of the computing device(s) 152, which may determine the folder and/or file formatting.

Some embodiments of the computing device(s) 152 include processing device(s) 356 communicably coupled to such components as the memory device(s) 368, the communication adapter 367, the input/output adapter 378, the disk drive adapter 372, and/or the like. The processing device(s) 356, and other processors described herein, generally include circuitry for implementing communication and/or logic functions of the system. For example, the processing device(s) 356 may include a digital signal processor device, a microprocessor device, and various analog to digital converters, digital to analog converters, and/or other support circuits. Control and signal processing functions of the computing device(s) 152 are allocated between these devices according to their respective capabilities. The processing device(s) 356 thus may also include the functionality to encode and interleave messages and data prior to modulation and transmission. The processing device(s) 356 can additionally include an internal data modem. Further, the processing device(s) 356 may include functionality to operate one or more software programs, which may be stored in the memory device(s) 368. For example, the processing device(s) 356 may be capable of operating a connectivity program to communicate via the communication adapter 367.

The processing device(s) 356 is configured to connect to the network 100 via the communication adapter 367 to communicate with one or more other devices on the network 100. In this regard, the communication adapter 367 may include various components, such as an antenna operatively coupled to a transmitter and a receiver (together a “transceiver”). The processing device(s) 356 is configured to provide signals to and receive signals from the transmitter and receiver, respectively. The signals may include signaling information in accordance with the air interface standard of the applicable cellular system of the network 100. In this regard, the computing device(s) 152 may be configured to operate with one or more air interface standards, communication protocols, modulation types, and access types. By way of illustration, the computing device(s) 152 may be configured to operate in accordance with any of a number of first, second, third, fourth, and/or fifth-generation communication protocols and/or the like).

The I/O adapter 378, which allow the computing device(s) 152 to receive data from a user such as a system administrator, may include any of a number of devices allowing the computing device(s) 152 to receive data from the user, such as a keypad, keyboard 381, touch-screen, touchpad, microphone, mouse, joystick, other pointer device, button, soft key, and/or other input device(s). The user interface may also include a camera, such as a digital camera.

The disk drive adapter 372 may provide additional storage space via disk storage 370. Various other storage mediums may also be used by the computing device(s) 152, such as cloud storage (e.g., transmitted via the communication adapter 367).

As described above, the computing device(s) 152 has a user interface that is, like other user interfaces described herein, rendered via the display device 380. The display device 380 include a display (e.g., a liquid crystal display or the like) and/or a speaker or other audio device, which are operatively coupled to the processing device(s) 356. As such, the folder(s) and/or file(s) discussed herein may be provided to the computing device(s) 152 via the display device 380 (e.g., visually via the user interface). in various embodiments, the display device 380 may be in communication with a sound card 374 (e.g., attached to a microphone 376 and/or a speaker 377 (e.g., the speaker 377 may be part of the display device 380 or standalone)).

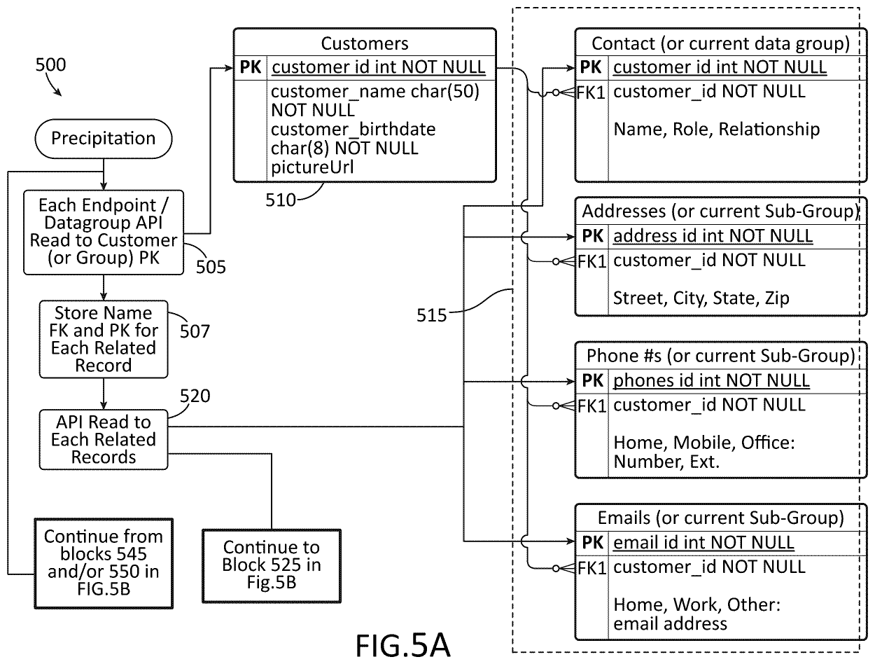

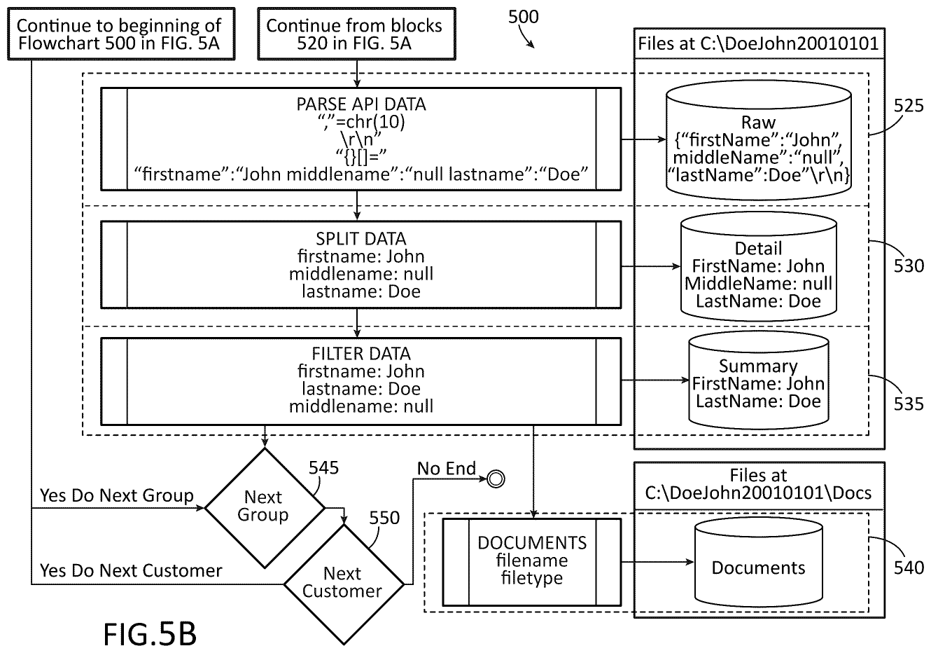

Referring now to FIG. 4, a flowchart 400 is provided illustrating the high-level structure of data to be processed as discussed herein, such as during the operations of FIGS. 5A, 5B, and 10. The operations are discussed in more detail in reference to FIGS. 5A, 5B, and 10. In various embodiments, the data structured in FIG. 4 may be structure in which the information is received by the system (e.g., from a third party data management system 175). Additionally or alternatively, the system may divide the data into the structure shown. Dividing the data base on the data fields may be based on the format of the data received from the third party data management system 175. In various embodiments, FIG. 4 illustrates how entity data provided by a third party data management system 175 may be configured.

Referring now to Block 401 of FIG. 4, the entity data may include all of the data received by the system for processing. As shown, the entity data may relate to customer information. The type of entity data in Block 401 may indicate how the data is structured and processed as discussed herein. The entity data of Block 401 (e.g. customer data) may be sorted into separate data groups as shown in Block 402. The entity data may include any number of data groups. For example, the example shown in FIG. 4 includes “Contact Information”, “Notes”, and “Intake” as the data groups.

Each data group may be subdivided into data sub-groups, as shown in Block 403. Each data group may have any number of data sub-groups. For example, Contact Information has three data sub-groups (“Addresses”, “Phone Numbers”, and “Emails”); Notes has one data sub-group (“Messages”), and Intake has five data sub-groups (“Facts”, “Damage”, “Photos”, “Videos”, and “Teams”). Data sub-groups may also be sub-divided into other data sub-groups (e.g., “Damage” has a “Mechanical” and “Cosmetic” sub-group, and “Teams” has a “Mechanical Team” and a “Paint/Body Team” sub-group).

The data groups and sub-groups shown in FIG. 4 are merely example data groups and data sub-groups. Various different data groups and/or sub-groups may be used based on the data being processed. The data groups and/or the data sub-group may be automatically determined (e.g., the system may determine data groups and/or data sub-groups based on the data being processed). For example, the system may determine data groups and/or data sub-groups based on how the entity data was stored relative to one another. Additionally or alternatively, the data groups and/or data sub-groups may be user defined (e.g., a user may determine the data groups based on an entity data for a single identification record (e.g., customer) and the system may carry out the operations throughout the other identification records in the entity data).

Referring now to FIGS. 5A and 5B, the flowchart 500 illustrates the operations of an example embodiment in which data is precipitated across disparate segments of computing infrastructure. FIGS. 5A and 5B illustrate how the entity data shown in Block 401 of FIG. 4 is processed in accordance with an example embodiment. A more detailed description of an example technical flow of precipitating data from the data groups and data sub-groups represented in FIG. 4 is shown in FIGS. 5A and 5B.

As shown in FIGS. 5A and 5B, the data groups are identified, and the number of unique data groups is recorded (e.g., recorded in local memory). The identification records, in this example case, customers, are then located. Referring to Block 505 and Block 510 of FIG. 5A, the Customer ID or Primary Key (PK) (e.g., the identification record) may be located and used to build the API URL for the API call. Sub-Group Foreign Keys (FK) are used to identify Sub-Group primary keys, as shown in Block 515 to be used in the API call to collect data related to the main data group record and to be subsequently processed and written to the appropriate file which is grouped by that data group. Each of the primary key(s) and/or foreign key(s) may be stored for each record, as shown in Block 507 of FIG. 5A. The API calls are made to the sub-groups to retrieve the sub-group data and results may be stored (e.g., stored in local memory). As shown in Block 520 of FIG. 5A, the API may be used to read each of the data groups for the entity data associated with the given identification record.

The data (e.g., data stored in local memory) associated with the given identification record for the given data group may be parsed, as shown in Block 525 of FIG. 5B, as the first step in preparing the data to be written to the appropriate file. At this point in the process, the raw data from the API call that was stored in local memory will be written to the Raw file for this data group (e.g., raw file 600 shown in FIG. 6A).

As shown in Block 530 of FIG. 5B, the raw data is then split into individual data field and response pairs such that each pair can be written to one line in the detailed file for the given data group. Concurrently or sequentially, as shown in Block 535 of FIG. 5B, the data is filtered to remove any null value fields from data field and response pairs and that data is written to the summary file for this Data Group (e.g., with any data fields with NULL responses removed). In an instance in which the particular data group or data sub-group contains documents, then those documents, in the document's original form, may be written to the file location in the documents sub-folder of the folder associated with the identification record, as shown in Block 540 of FIG. 5B.

At Block 545 of FIG. 5B, the index number of the current data group being processed is compared to the total number of data groups to determine whether any additional data groups are to be processed for the given identification record. In an instance in which additional data groups remain to be processed, the operations are repeated for the next data group. In an instance in which each data group is processed for a given identification record, the system may repeat the operations on the next identification record (e.g., as shown in Block 550 of FIG. 5B). Once the last identification record is completed, the operations are terminated. The operations may be repeated via an automatic and/or a manual trigger. While the operations are discussed with storing data in local memory, the data discussed in reference to FIGS. 5A and 5B may be stored locally or otherwise.

Referring now to FIGS. 6A-6C, various different files generated using the operations herein are shown. The files of FIGS. 6A-6C illustrate example files that may be stored in a folder associated with a given identification record. Example files include raw file(s), detailed file(s), and/or summary file(s) for each data group. FIGS. 6A-6C are illustrated as .txt files. However, any number of different file types may be used for the files generated using the operations discussed herein. As such, the files (e.g., raw file(s), detailed file(s), and/or summary file(s)) may include. pdf files, .doc files, .docx files .txt files, and/or the like.

FIG. 6A illustrate an example raw file for an identification record. The raw file associated with a given identification record (e.g., a first identification record, a second identification record, etc.) includes the syntax used by the third party data management system 175. As such, the information relating to the data field(s) and responses to given data fields are included, but are not readable. In various embodiments, readable indicates that the data field and/or response is easily discernible for a user. As shown, the data in the raw file 600 may be one or more strings of characters that include the data fields, the response(s), and syntax used by the third party data management system 175 to process and display the data. However, as most third party data management systems use proprietary techniques are data management, the string of characters in the raw file may be difficult or in some cases impossible to process. As such, the operations herein are completed to make the information readable (e.g., as shown in the detailed file of FIG. 6B and/or the summary file of FIG. 6C).

FIG. 6B illustrates an example detailed file 605 for an identification record. The detailed file includes each data field and any responses to the data field. The detailed file includes NULL responses to data fields. For example, data may not be provided for a given data field and the NULL response will be noted in the detailed file. Each data field and corresponding response (e.g., actual response or NULL response) are separated (e.g., as shown, each data field and corresponding response is provided on a single line) to be easily viewed (e.g., by the system and/or by a user) and/or processed by a system. As shown, the detailed file 605 may correspond to a specific data group. For example, the detailed file 605 is the detailed file associated with a given identification record for the “Contact” data group.

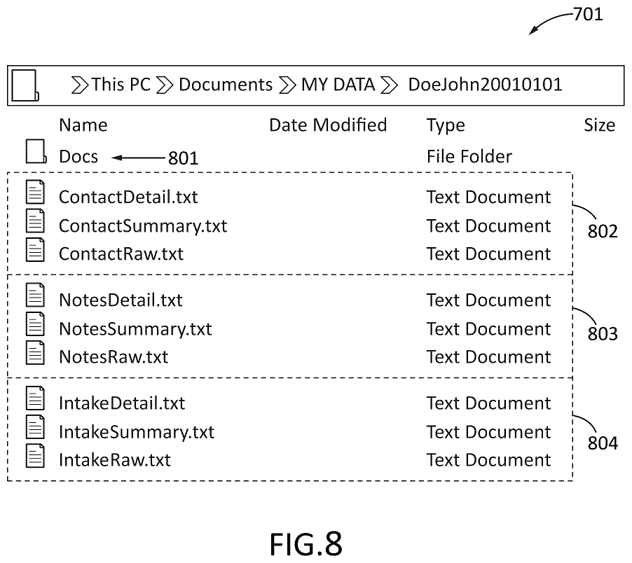

FIG. 6C illustrates an example summary file 610 includes any data fields and response in which a response was provided. As such, the system may remove any data fields that had NULL values. As such, the summary file 610 includes every response for the given identification record for the given data group. For example, the summary file 610 of FIG. 6C provides each response for the given identification record for the “Contact” data group. As shown in FIG. 8, each of the raw file, the detailed file, and/or the summary file may be provided in the folder associated with the given identification record. In various embodiments, any number of files may be provided based on the number of data groups and/or data sub-groups for the entity data.

Referring now to FIGS. 7-9, example file organization is shown using the operations herein. FIG. 7 illustrates each identification record (e.g., a user in this instance) having an individual folder within an entity folder 700. FIG. 8 illustrates the contents of a folder 701 associated with a given identification record (e.g., a first identification record for “Doe, John”). FIG. 9 illustrates the location of documents associated with a given identification record (e.g., the first identification record for “Doe, John”).

FIG. 7 illustrates each of the folders generated for the identification records. In various embodiments, the entity folder 700 is structured to include a folder for each identification record included in the data being precipitated. For example, as shown, the data may have multiple identification records corresponding to different people (e.g., folder 701 associated with a first John Doe, folder 702 associated with a second John Doe, folder 703 associated with Jane Evans, etc.). As such, the operations herein allow for the entity folder to be easily navigable, such that a folder associated with a given identification record may be easily found and selected. In various embodiments, the naming convention for the folder associated with a given identification record may be based on the identification record. For example, in an instance in which the identification record includes a name, the folder name for the folder associated with the given identification record includes at least a portion of the name. While the example shown uses names for identification records, any number of different alphanumerical identification records may be used, such as identification numbers. The operations herein may be extended to different types of data, such that the identification record may be any number of different identifiers that are used to separate data for efficient consumption.

In some instances, a single identification record may correspond to two different sets of records. For example, as shown in FIG. 7, multiple people may have the same name, such that the identification record may be the same for both people. As such, to avoid confusion, the system may include one or more unique alphanumerical characters to the folder name for an identification record such that the same identification records may be differentiated. Any number of different unique alphanumerical character(s) may be used. For example, a person's birthdate may be added to allow for differentiation. In various embodiments, the unique alphanumerical character(s) may be based on information relating to the identification record (e.g., the birthdate of a given person). Alternatively, the unique alphanumerical character(s) may be generated randomly (e.g., the randomly generated unique alphanumerical character(s) may be stored for reference to determine different identification records).

FIG. 8 illustrates the contents of a folder associated with a given identification record (e.g., folder 701 associated with John Doe shown in FIG. 7). A folder associated with a given identification record may include a document folder 801. The document folder 801 (shown in FIG. 9) includes any documents associated with the given identification record. The folder associated with the given identification record may also include one or more files as discussed in more detail in reference to Block 1040 of FIG. 10. The file(s) may include a detailed file, a summary file, and/or a raw file. As shown, the files may be separated based on data groups (e.g., Contact, Notes, Intake). The data groups are discussed in more detail in reference to FIG. 4. In various embodiments, each of the data groups may have a detailed file, a summary file, and/or a raw file. For example, the files corresponding to the data group “Contact” are shown in Block 802, the files corresponding to the data group “Notes” are shown in Block 803, and the files corresponding to the data group “Intake” are shown in Block 804. Example files are shown in FIGS. 6A-6C discussed above.

FIG. 9 illustrates example documents associated with a given identification record (e.g., John Doe). The documents are stored within the document folder 801 shown in FIG. 8. The documents may be stored to avoid any lost information that may be stored only as an attachment to the files discussed herein. For example, a document may be saved to a file corresponding to the identification record and no corresponding entries may be made that would be entered into the data packet(s) to be processed. The documents in the document folder 801 may be subdivided into sub-folders based on the file path of one or more documents. The sub-folders may be based on document origin, document type, document usage, and/or the like. In various embodiments, the operations of subdividing the folders may be discussed in reference to FIGS. 12-13.

Referring now to FIG. 10, a flowchart 1000 is illustrated for reformatting data in accordance with various embodiments. In various embodiments, the method of FIG. 10 may be carried out using processing device(s), such as a processing device within one or more computing device(s) 152. As such, the operations herein may be carried out by any of the embodiments herein unless otherwise stated. Unless otherwise stated, the operations of FIG. 10 may be carried out by the same system, such as the systems of various embodiments discussed herein.

Referring now to Block 1010 of FIG. 10, the method includes receiving one or more first data packets. Each of the one or more first data packets include one or more data fields for which a response is capable of being recorded. The first data packet(s) may include information similar to the raw file 600 shown in FIG. 6A. The first data packer(s) may be in the format used by the third party data management system 175.

The first data packet(s) may be included in the entity data obtained from a third party, such as via an API. For example, a third party data management system (e.g., cloud-based or otherwise) may store entity data for an entity. Processing the entity data typically requires using the third party data management system's programs to properly use or render the data. Such a third party may be required or otherwise provide the entity with an opportunity to download or otherwise access the entity data. However, the entity data received by the entity may be formatted for processing by the third party data management system and otherwise be non-readable (e.g., such as the raw file 600 shown in FIG. 6A). As such, the entity data may be received in the form of multiple raw files corresponding to one or more identification records (e.g., for a business, the identification records may correspond to customers). Such raw files may be considered a “data packet” for the operations herein.

Each of the one or more first data packets are associated with a first identification record. For example, a first data packet(s) may be any raw files that are associated with a first identification record. In various embodiments, the first data packet(s) may be received along with other data packet(s) (e.g., second data packet(s) corresponding to a second identification record, third data packet(s) corresponding to a third identification record, etc.).

As discussed herein, an identification record (e.g., a first identification record, a second identification record, etc.) may be any alphanumerical identifier used to differentiate the entity data. In various embodiments, the identification record may correspond to individual persons or customers. Any number of different identification record types may be contemplated based on the data being processed (e.g., by person, by business, by data type, etc.). As such, the identification record may be any alphanumerical value. For example, a first identification record may be indicated by a first identification value (e.g., a name, a username, an identification number, etc.).

While the operations of FIG. 10 are discussed in reference to first data packet(s) associated with a first identification record, the operations may be carried out for any number of identification records (e.g., a second identification record, a third identification record, a fourth identification record, etc.). In various embodiments, the first data packet(s) may be a subset of a larger set of data packet(s) received by the system. For example, the system may include determining one or more identification records associated with a given data packet. In various embodiments, the system may determine the portions of the data packet(s) that are associated with the first identification record and such portions of the data packet(s) are considered the first data packet(s). Additionally, the same operations may be repeated across additional identification records (e.g., a second identification record, a third identification record, a fourth identification record, etc.).

Referring now to Block 1020 of FIG. 10, the method includes converting each of the one or more first data packets into a readable textual format. Converting each of the one or more first data packets into the readable textual format may include removing at least one syntax value from the one or more first data packets. The conversion of the data packet(s) may also include determining the data fields and responses corresponding to the given data fields. Example conversion are shown in FIGS. 6B and 6C.

In various embodiments, the one or more first data packets may include JSON strings of text that include the data fields and responses, along with JSON syntax. In such an embodiment, the conversion of the first data packet(s) into a readable textual format includes removing the JSON syntax from the JSON string. The conversion of the first data packet(s) into a readable textual format includes determining each data field within the JSON string and the corresponding response (or NULL response) within the JSON string. An example first data packet is shown in the raw file of FIG. 6A. Example readable textual format of the first data packet is shown in the detailed file of FIG. 6B.

In various embodiments, the one or more first data packets may be in the form of one or more databases that contain the data fields and responses. For example, the third party data management system 175 may store the entity data in the database(s), such that the entity may receive access or otherwise download the database(s) with the entity data. In such an instance, the system may determine data fields and/or responses based on the entries into the database(s). In various embodiments, each data field within the database(s) may be determined and each corresponding response (or NULL response) may be determined based on the database(s).

Referring now to optional Block 1030 of FIG. 10, the method includes sorting each of the one or more first data packets based on at least one data group. The at least one data group is based on a data type. Example entity data structure is shown and discussed in reference to FIG. 4. In various embodiments, the sorting of the data packets into data groups may be based on the method in which the entity data is received from the third party data management system 175. For example, the data groups and/or data sub-groups may be determined based on the raw files received from the third party data management system 175. As such, sorting each of the one or more first data packets based on the at least one data group includes determining the at least one data group. In various embodiments, sorting each of the one or more first data packets based on the at least one data group includes determining at least one data sub-group with the at least one data group. In such an instance, each of the at least one data sub-group includes data relating to the first identification record.

Referring now to Block 1040 of FIG. 10, the method includes generating a folder associated with the first identification record, wherein the folder associated with the first identification record comprises at least one file associated with the first identification record. Example folders are shown in FIGS. 7-9. As discussed, the entity folder 700 includes one or more folders for each identification record (e.g., folder 701 associated with a first John Doe, folder 702 associated with a second John Doe, folder 703 associated with Jane Evans, etc.). As such, the system may generate the entity folder for the entity data and the corresponding folder associated with each of the identification records.

In various embodiments, the method may include determining the folder name for the folder associated with the given identification record. The folder name may be based on the given identification record. For example, the folder name may include at least a portion of the identification record (e.g., the folder name may include the name of a customer in an instance in which the identification record is the customer name).

In various embodiments, the folder name for the folder may include one or more unique alphanumerical characters based on the first identification record. Any number of different unique alphanumerical character(s) may be used. For example, a person's birthdate may be added to allow for differentiation. In various embodiments, the unique alphanumerical character(s) may be based on information relating to the identification record (e.g., the birthdate of a given person). Alternatively, the unique alphanumerical character(s) may be generated randomly (e.g., the randomly generated unique alphanumerical character(s) may be stored for reference to determine different identification records).

In various embodiments, the folder associated with a given identification record may include one or more files. The file(s) may include raw file(s), detailed file(s), and/or summary file(s) associated with the given identification record. Example raw file, detailed file, and summary file are shown and discussed in more detail in reference to FIGS. 6A-6C.

As discussed above in reference to FIG. 8, the file(s) in the folder associated with given identification record may be corresponding to a data group. For example, a raw file, a detailed file, and/or a summary file may be generated for each data group and stored in the folder corresponding to the given identification record. Additionally, as shown in FIGS. 8 and 9, a document folder 801 may also be provided to store any documents associated with the given identification record. The document folder 801 may be stored in the folder associated with the given identification record.

Referring now to Block 1050 of FIG. 10, the method includes storing the readable textual format of the one or more first data packets in the folder associated with the first identification record. The readable textual format may include the detailed file(s) and/or the summary file(s) discussed herein. In various embodiments, the folder associated with the given identification record (and additional folders associated with other identification records) may be stored locally and/or remotely.

In various embodiments, the method of FIG. 10 may be carried out by a system including at least one non-transitory storage device and at least one processing device coupled to the at least one non-transitory storage device. In such an embodiment, the at least one processing device is configured to carry out the method of FIG. 10. Additionally, a computer program product may be provided to carry out the method of FIG. 10 upon execution. The computer program product of an example embodiment includes at least one non-transitory computer-readable medium having one or more computer-readable program code portions embodied therein. In such an embodiment, the one or more computer-readable program code portions include at least one executable portion configured to carry out the method of FIG. 10.

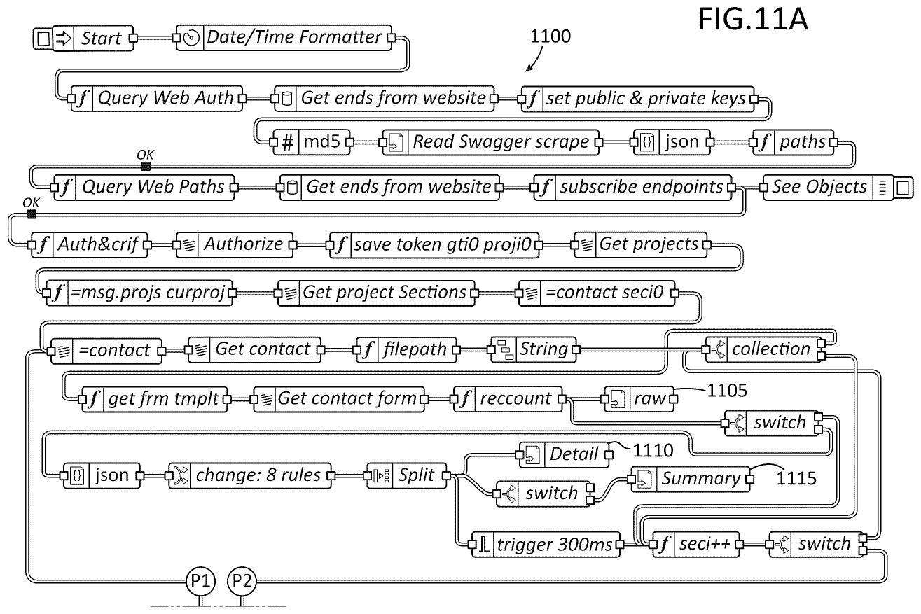

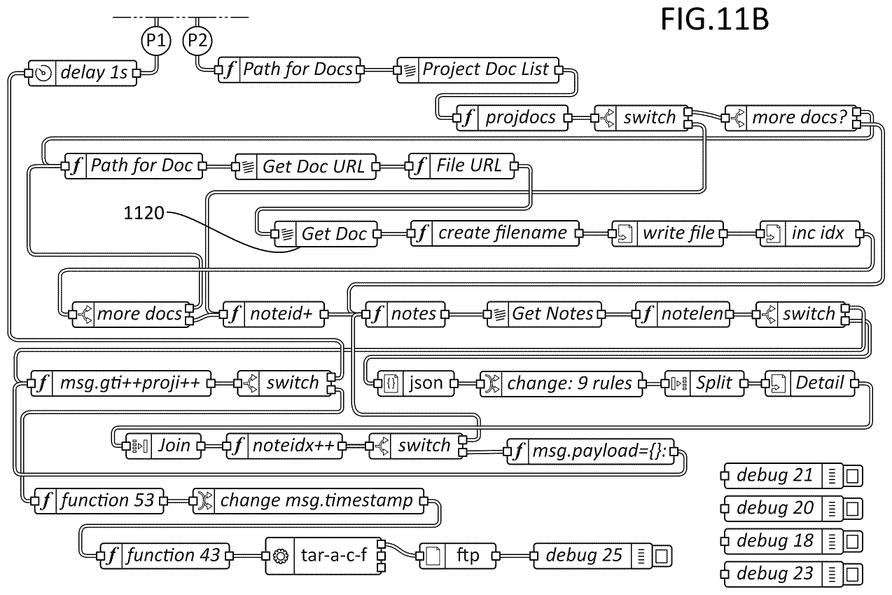

Referring now to FIGS. 11A and 11B, an example flow diagram used to program code for an example implementation of the operations discussed herein. The flow diagram 1100 is illustrative and not exclusory of other implementation methods and/or designs. As shown, the operations are the actual implementation of the flowchart 500 shown in FIGS. 5A and 5B. For example, the entity data is obtained and processed to produce the raw file (e.g., raw 1105), the detailed file (e.g., Detail 1110), and the summary file (e.g., Summary 1115) for a first data group (“Contact”). Additionally, any documents associated with an identification record are also retrieved (e.g., GET Doc 1120). Various other operations are completed in accordance with the operations discussed herein.

Referring now to FIGS. 12 and 13, method of associating precipitated data are provided. FIG. 12 is a flowchart of an example method for associating precipitated data. Namely, associating document(s) referenced in precipitated data for use upon precipitation. In various embodiments, the operations of FIGS. 12 and/or 13 may be carried out with the operations discussed herein, such as the operations discussed in reference to FIG. 10. For example, the association of documents may be completed during the precipitation and reformatting process discussed in reference to FIG. 10. In various embodiments, the operations of FIGS. 12 and/or 13 may be carried out using processing device(s), such as a processing device within one or more computing device(s) 152.

While FIGS. 12 and 13 refer to a first document, a first data packet, a first identification record, etc., any number of different documents, data packets, identification records, etc. may be contemplated by the operations herein. For example, a first document may reference multiple documents (e.g., a first document, a second document, etc.). Additionally, the operations performed on the first document may be performed on any number of documents (e.g., a second document, a third document, etc.).

In various embodiments, the term documents may refer to any number of different document types (e.g., .docx, .pdf, .jpg, .png, .xlsx, .pptx, etc.). As discussed herein, the documents may be referenced in the data precipitated. In various embodiments, the documents may be retrieved during the data precipitation. However, without the operations discussed herein, there is no way to determine the interconnection of the precipitated data and the documents.

In various embodiments, the term “file path” may refer to the file path of a given document (e.g., a first document). The file path may include a progression of directories and/or folders to access the given document. The file path discussed herein may refer to the file path in data before precipitation (e.g., file path may be the file path of the document being stored via a third party for use via a third-party interface). In various embodiments, the operations discussed herein identify the file path of the precipitated data and update the file path upon placement into the given document sub-folder. In various embodiments, the file path may be updated for a document upon placement into a document sub-folder. For example, the file path for a document may be updated to reference the current file path of the document stored in the given document sub-folder. The file path referenced in one or more files (e.g., summary files and/or detailed files) may be updated as discussed in reference to the operations of FIG. 13.

Referring now to Block 1210 of FIG. 12, the method includes receiving a first data packet. In various embodiments, receiving of the first data packet may be the same as the receiving of the one or more first data packets discussed in reference to Block 1010 of FIG. 10. For example, the first data packet includes one or more data fields for which a response is capable of being recorded. The first data packet(s) may include information similar to the raw file 600 shown in FIG. 6A. The first data packer(s) may be in the format used by the third party data management system 175.

In various embodiments, a data packet (e.g., a first data packet) may reference one or more documents (e.g., a first document). The document(s) may be reference in at least one data field of the data packet (e.g., the first document may be referenced in at least one data field of the first data packet). Each data packet and any documents referenced within the data packet may be associated with an identification record. For example, the first data packet and the first document may be associated with the first identification record. Any number of data packets may be received and any number of documents may be referenced in each data packet. As such, the operations may be repeated across multiple data packets.

In various embodiments, the first document may be provided along with the first data packet (e.g., the first data packet and/or subsequent transmissions may include the first document). In various embodiments, the system may receive instructions for accessing and/or downloading documents referenced in a data packet (e.g., the document(s) referenced within the data packet(s) may be received separately from the reception of the data packet(s)).

Referring now to Block 1220 of FIG. 12, the method includes determining at least one of a document type or a file path associated with the first document. In various embodiments, the document type and/or file path associated with the first document may be determined based on the API endpoint from which the data packet(s) and/or the first document is received. The file path of a document may be the file path of the document before data precipitation. For example, the precipitated data may reference the file path of a document at the storage location before data precipitation (e.g., a document stored on a cloud memory device may be referenced in precipitated data).

In various embodiments, the document type may merely be the type of document (e.g., the file type, such as.docx, .pdf, .xslx, .png, jpg, and/or the like). The document type may be determined on the name of the document (e.g., the document type of “Quote.pdf” shown in FIG. 9 is PDF). The system may also perform verification on the document to determine the document type (e.g., a certain type of document may be accessible via a certain program). For example, a PDF document may be accessed via a PDF viewer to verify.

In various embodiments, the file path of the document may be determined (e.g., replicated) based on the API endpoint. The file path of a document may be associated with the document location before data precipitation. For example, the API call that resulted in the document being part of the given data packet may indicate the file path. In various embodiments, the API endpoint and/or API call used to retrieve the document may be used as a proxy for the file path of the document. For example, the system may operate as though the API endpoint and/or API call used to retrieve the document is the file path to identify associated data packets. For example, the system may receive one or more data packets from an API endpoint and one or more documents (e.g., a first document) may be included in the data packet(s) (e.g., a first data packet). In such an instance, the system may determine the file path of the document and the documents relatedness to the data packet(s) based on the data being received via the same API endpoint and/or API call. As such, the system may identify the portions of precipitated data in which a document is referenced and replicate the file path. The replicated file path of the document may then be used as discussed herein.

Referring now to optional Block 1230 of FIG. 12, the method includes generating metadata associated with the file path for the first document. The metadata may include information relating to the file path of the first document. In various embodiments, the metadata may include information for the data packets that reference the first document. For example, the metadata associated with the first document may indicate one or more data packets that reference or otherwise use the first document. The metadata may include the original and/or replicated file path (e.g., before data precipitation) and/or the updated file path (e.g., after the file has been stored in the given document sub-folder). In various embodiments, the metadata may be updated after the first document is stored in the first document sub-folder.

Referring now to Block 1240 of FIG. 12, the method includes assigning the first document to a first document sub-folder of one or more document sub-folders. Example of a document folder is shown in FIG. 9. In various embodiments, the document sub-folders may be positioned within the document folder. In various embodiments, while the document sub-folder may be referred to as a “sub-folder”, in various embodiments, a document sub-folder may be an individual folder. In various embodiments, the term “sub-folder” may refer to a folder within a folder (e.g., a nested folder). The one or more document sub-folders need not necessarily be stored within the same folder. However, in some embodiments, each of the one or more document sub-folders may be stored within the same folder.

The assignment of the document sub-folder (e.g., the assignment of the first document to the first document sub-folder) may be based on the document type, the file path of the document, and/or the like. Any number of documents may be saved to a given document sub-folder. As such, the first document sub-folder may include any number of documents. Each document in a given document sub-folder may be related in some way. For example, each document in a given document sub-folder may be referenced in the same data packet (e.g., the first data packet), referenced in data packets associated with the same identification record (e.g., documents in the same document sub-folder may be reference by one or more data packets associated with a given identification record), include the same data types, and/or the like. In various embodiments, the document type generated may be used to determine similarities (e.g., multiple documents may be referenced in the same portion of a data packet).

In various embodiments, any documents with the same document type and associated with the same identification record may be assigned and/or stored in the same document sub-folder. For example, PDF documents may be assigned and/or stored to a first document sub-folder associated with a first identification record and Word documents may be assigned and/or stored in second document sub-folder associated with a first identification record. In various embodiments, additional subdividing may occur. For example, the documents may assigned to a document sub-folder based on document type and the data packet in which the document is referenced. Any number of document sub-folders may be contemplated using various factors, such as document type, data packet in which the document was referenced, file type of the document, and/or the like.

In various embodiments, the file path of the document (e.g., before the data precipitation) may be used to assign a document to a document sub-group. For example, the file path of the document may be determined via the API endpoint and the file path may be associated with the document location before data precipitation. For example, the API call that resulted in the document being part of the given data packet may indicate the file path.

As discussed herein, a data packet (e.g., the first data packet) may reference any number of documents (e.g., a first document and/or additional documents). As such, the operations discussed herein may be carried out across multiple documents referenced in a data packet. For example, the first data packet may reference one or more additional documents in the at least data field and each of the one or more additional documents are also assigned to one of the one or more document sub-folders (e.g., either the same or different from the first document sub-folder).

Referring now to Block 1250 of FIG. 12, the method includes storing the first document in the first document sub-folder. Each of the one or more document sub-folders may be stored locally and/or on the cloud. In various embodiments, during data precipitation, the data may be provided to a computing device. The computing device may store the precipitated data locally. In various embodiments, the structure of the data storage matches the structure discussed herein. For example, one or more files (e.g., raw files, detailed files, summary files) and/or documents from the precipitated data may be stored locally. The local storage may be part of a backup (e.g., in case of the data being lost) and/or part of a data transfer (e.g., in an instance in which a third party vendor subscription ends, the data may be provided to the associated entity).

As discussed herein, each of the one or more document sub-folders may be associated with a given identification record. Additionally or alternatively, the one or more document sub-folders may contain one or more documents. The one or more documents may have a similarity with one another, such as having the same file path, having the same document type, and/or being associated with the first identification record.

In various embodiments, the precipitated data may be organized based on identification record. As such, the information in a given folder may be associated with the same identification record. The document folders may also be stored based on identification record. For example, as shown in FIG. 7, each identification record (e.g., DoeJohn20010101) may have folder(s) with associated data (e.g., detail file(s), summary file(s), raw file(s), and/or document(s)) from the precipitated data. The document folder 801 (shown with example contents in FIG. 9) may include any documents referenced by and/or otherwise associated with the precipitated data. In various embodiments, the document sub-folder(s) may be stored within the document folder 801. As such, each identification record may have a document folder and associated documents sub-folder(s). In various embodiments, the document sub-folder(s) may be stored directly in the folder shown in FIG. 8.

FIG. 13 is an additional flowchart of an example method for associating precipitated documents in a data packet. As discussed above, any of the operations of FIG. 13 may be carried out by the system that carries out the operations of FIG. 10 or 12.

Referring now to Block 1310 of FIG. 13, the method includes receiving a first data packet. In various embodiments, receiving of the first data packet may be the same as the receiving of the one or more first data packets discussed in reference to Block 1010 of FIG. 10 and/or Block 1210 of FIG. 12. While the operations are discussed in reference to a single data packet, any number of data packets may be received and/or processed as discussed herein. For example, a data precipitation may include multiple data packet(s) associated with one or more identification records. In various embodiments, any number of data packet(s) may be processed and assigned to the document sub-folder(s) as discussed herein.

In various embodiments, the first data packet may include one or more data fields that references a first document. The first data packet may also reference one or more additional documents. The documents may be processed, as discussed herein in reference to FIGS. 12 and/or 13.

Referring now to Block 1320 of FIG. 13, the method includes converting the first data packet into a readable textual format. The conversion into a readable textual format may the same as the operations discussed in reference to Block 1020 of FIG. 10. For example, a raw file received via a first data packet may be converted into a detailed file and/or a summary file (e.g., removing any syntax values). Example readable textual formats of a data packet are shown in FIGS. 6B and 6C. As shown, a pictureURL is provided. In various embodiments, the system may update the information associated with the pictureURL to reference the document sub-folder in which the referenced picture is stored. As such, the documents stored within the document folder 801 (shown in FIGS. 8 and 9) may be referenced to assist in using the data in the given file.

Part of the conversion to a readable textual format may include providing reference to the document location for documents referenced in the given file. For example, a document referenced in a precipitated file may be hyperlinked and/or otherwise directed (e.g., via a non-hyperlink storage location of the given document). As such, the document reference in the given file (e.g., the detailed file and/or the summary file) may direct to the location of the given document within a document sub-folder. For example, in an instance in which a first document is referenced in a first data packet, the readable textual format of the first data packet may include the location of the first document sub-folder.

Referring now to Block 1330 of FIG. 13, the method includes retrieving the first document from the first document sub-folder based on an engagement of the hyperlink to the first document. In various embodiments, the reference to a given document may be hyperlinked and/or otherwise reference the storage location (e.g., the document sub-folder) for the document. For example, a first document may be hyperlinked in a detailed file and/or a summary file of precipitated data. The hyperlink may allow a user and/or program interacting with precipitated data to quickly access the associated documents.

The ability to reference the document sub-folder for a document in the precipitated data is important for allowing easier processing and/or use of the data. As discussed herein, precipitated data is often meant for use via a third party interface. The present disclosure provides the ability to understand the content of the data (e.g., via the detailed file(s) and/or the summary file(s) being in a readable textual format) and also better understand how the data is interconnected. In current embodiments, documents associated with data precipitation may be provided or accessible, but how the documents relate to the precipitated data is nonexistent. As such, various embodiments of the present disclosure allow for associated documents to be stored and/or accessed in a way that a user may understand without the need for proprietary interfaces. This is especially important for large scale data precipitation in which the number of documents may be high and the ability of a human to completely understand how the documents relate to the precipitated data is impossible.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### III. Claim Clauses

Clause 1. A method for associating precipitated data, the method comprising: receiving a first data packet, wherein a first document is referenced in at least one data field of the first data packet, and wherein the first data packet and the first document are associated with a first identification record; determining at least one of a document type or a file path associated with the first document; assigning the first document to a first document sub-folder of one or more document sub-folders, wherein the assignment is based on the at least one of the document type or the file path of the first document; and storing the first document in the first document sub-folder, wherein each of the one or more document sub-folders contains one or more document that have a same file path and are associated with the first identification record.

Clause 2. The method of Clause 1, further comprising converting the first data packet into a readable textual format, wherein the readable textual format includes reference to the first document sub-folder in the at least one data field that references the first document.

Clause 3. The method of Clause 2, wherein the readable textual format of the first data packet is stored as at least one of a detailed file or a summary file, wherein the at least one of the detailed file or the summary file references the first document sub-folder.

Clause 4. The method of Clause 3, wherein the at least one of the detailed file or the summary file comprises a hyperlink to the first document stored in the first document sub-folder.

Clause 5. The method of Clause 1, wherein the first document sub-folder is stored within a folder associated with the first identification record.

Clause 6. The method of Clause 1, wherein the first data packet references one or more additional documents in the at least data field, wherein each of the one or more additional documents are assigned to one of the one or more document sub-folders.

Clause 7. The method of Clause 1, wherein determining the file path of the first document is based on an API endpoint from which the first document is received.

Clause 8. The method of Clause 1, wherein each of the one or more documents sub-folders are stored within a folder associated with the first identification record.

Clause 9. The method of Clause 8, wherein the folder associated with the first identification record is based on the first identification record.

Clause 10. The method of Clause 1, further comprising generating metadata associated with the file path for the first document.

Clause 11. A system for associating precipitated data, the system comprising: at least one non-transitory storage device; and at least one processing device coupled to the at least one non-transitory storage device, wherein the at least one processing device is configured to: receive a first data packet, wherein a first document is referenced in at least one data field of the first data packet, and wherein the first data packet and the first document are associated with a first identification record; determine at least one of a document type or a file path associated with the first document; assign the first document to a first document sub-folder of one or more document sub-folders, wherein the assignment is based on the at least one of the document type or the file path of the first document; and store the first document in the first document sub-folder, wherein each of the one or more document sub-folders contains one or more document that have a same file path and are associated with the first identification record.

Clause 12. The system of Clause 11, wherein the at least one processing device is further configured to convert the first data packet into a readable textual format, wherein the readable textual format includes reference to the first document sub-folder in the at least one data field that references the first document.

Clause 13. The system of Clause 12, wherein the readable textual format of the first data packet is stored as at least one of a detailed file or a summary file, wherein the at least one of the detailed file or the summary file references the first document sub-folder.

Clause 14. The system of Clause 13, wherein the at least one of the detailed file or the summary file comprises a hyperlink to the first document stored in the first document sub-folder.

Clause 15. The system of Clause 11, wherein the first document sub-folder is stored within a folder associated with the first identification record.

Clause 16. The system of Clause 11, wherein the first data packet references one or more additional documents in the at least data field, wherein each of the one or more additional documents are assigned to one of the one or more document sub-folders.

Clause 17. The system of Clause 11, wherein determining the file path of the first document is based on an API endpoint from which the first document is received.

Clause 18. The system of Clause 11, wherein each of the one or more documents sub-folders are stored within a folder associated with the first identification record.

Clause 19. The system of Clause 18, wherein the folder associated with the first identification record is based on the first identification record.

Clause 20. The system of Clause 11, wherein the at least one processing device is further configured to generate metadata associated with the file path for the first document.

Clause 21. A computer program product for associating precipitated data, the computer program product comprising at least one non-transitory computer-readable medium having one or more computer-readable program code portions embodied therein, the one or more computer-readable program code portions comprising at least one executable portion configured to: receive a first data packet, wherein a first document is referenced in at least one data field of the first data packet, and wherein the first data packet and the first document are associated with a first identification record; determine at least one of a document type or a file path associated with the first document; assign the first document to a first document sub-folder of one or more document sub-folders, wherein the assignment is based on the at least one of the document type or the file path of the first document; and store the first document in the first document sub-folder, wherein each of the one or more document sub-folders contains one or more document that have a same file path and are associated with the first identification record.

Clause 22. The computer program product of Clause 21, wherein the one or more computer-readable program code portions comprise at least one executable portion further configured to convert the first data packet into a readable textual format, wherein the readable textual format includes reference to the first document sub-folder in the at least one data field that references the first document.

Clause 23. The computer program product of Clause 22, wherein the readable textual format of the first data packet is stored as at least one of a detailed file or a summary file, wherein the at least one of the detailed file or the summary file references the first document sub-folder.

Clause 24. The computer program product of Clause 23, wherein the at least one of the detailed file or the summary file comprises a hyperlink to the first document stored in the first document sub-folder.

Clause 25. The computer program product of Clause 21, wherein the first document sub-folder is stored within a folder associated with the first identification record.

Clause 26. The computer program product of Clause 21, wherein the first data packet references one or more additional documents in the at least data field, wherein each of the one or more additional documents are assigned to one of the one or more document sub-folders.

Clause 27. The computer program product of Clause 21, wherein determining the file path of the first document is based on an API endpoint from which the first document is received.

Clause 28. The computer program product of Clause 21, wherein each of the one or more documents sub-folders are stored within a folder associated with the first identification record.

Clause 29. The computer program product of Clause 28, wherein the folder associated with the first identification record is based on the first identification record.

Clause 30. The computer program product of Clause 21, wherein the one or more computer-readable program code portions comprise at least one executable portion further configured to generate metadata associated with the file path for the first document.

Therefore, the following is claimed:

1. A method for associating precipitated data, the method comprising:
receiving a first data packet, wherein a first document is referenced in at least one data field of the first data packet, and wherein the first data packet and the first document are associated with a first identification record;
determining at least one of a document type or a file path associated with the first document;
assigning the first document to a first document sub-folder of one or more document sub-folders, wherein the assignment is based on the at least one of the document type or the file path of the first document; and
storing the first document in the first document sub-folder, wherein each of the one or more document sub-folders contains one or more document that have a same file path and are associated with the first identification record.

2. The method of claim 1, further comprising converting the first data packet into a readable textual format, wherein the readable textual format includes reference to the first document sub-folder in the at least one data field that references the first document.

3. The method of claim 2, wherein the readable textual format of the first data packet is stored as at least one of a detailed file or a summary file, wherein the at least one of the detailed file or the summary file references the first document sub-folder.

4. The method of claim 3, wherein the at least one of the detailed file or the summary file comprises a hyperlink to the first document stored in the first document sub-folder.

5. The method of claim 1, wherein the first document sub-folder is stored within a folder associated with the first identification record.

6. The method of claim 1, wherein the first data packet references one or more additional documents in the at least data field, wherein each of the one or more additional documents are assigned to one of the one or more document sub-folders.

7. The method of claim 1, wherein determining the file path of the first document is based on an API endpoint from which the first document is received.

8. The method of claim 1, wherein each of the one or more documents sub-folders are stored within a folder associated with the first identification record.

9. The method of claim 1, further comprising generating metadata associated with the file path for the first document.

10. A system for associating precipitated data, the system comprising:
at least one non-transitory storage device; and
at least one processing device coupled to the at least one non-transitory storage device, wherein the at least one processing device is configured to:
receive a first data packet, wherein a first document is referenced in at least one data field of the first data packet, and wherein the first data packet and the first document are associated with a first identification record;
determine at least one of a document type or a file path associated with the first document;
assign the first document to a first document sub-folder of one or more document sub-folders, wherein the assignment is based on the at least one of the document type or the file path of the first document; and
store the first document in the first document sub-folder, wherein each of the one or more document sub-folders contains one or more document that have a same file path and are associated with the first identification record.

11. The system of claim 10, wherein the at least one processing device is further configured to convert the first data packet into a readable textual format, wherein the readable textual format includes reference to the first document sub-folder in the at least one data field that references the first document.

12. The system of claim 11, wherein the readable textual format of the first data packet is stored as at least one of a detailed file or a summary file, wherein the at least one of the detailed file or the summary file references the first document sub-folder.

13. The system of claim 12, wherein the at least one of the detailed file or the summary file comprises a hyperlink to the first document stored in the first document sub-folder.

14. The system of claim 10, wherein determining the file path of the first document is based on an API endpoint from which the first document is received.

15. A computer program product for associating precipitated data, the computer program product comprising at least one non-transitory computer-readable medium having one or more computer-readable program code portions embodied therein, the one or more computer-readable program code portions comprising at least one executable portion configured to:
receive a first data packet, wherein a first document is referenced in at least one data field of the first data packet, and wherein the first data packet and the first document are associated with a first identification record;
determine at least one of a document type or a file path associated with the first document;
assign the first document to a first document sub-folder of one or more document sub-folders, wherein the assignment is based on the at least one of the document type or the file path of the first document; and
store the first document in the first document sub-folder, wherein each of the one or more document sub-folders contains one or more document that have a same file path and are associated with the first identification record.

16. The computer program product of claim 15, wherein the one or more computer-readable program code portions comprise at least one executable portion further configured to convert the first data packet into a readable textual format, wherein the readable textual format includes reference to the first document sub-folder in the at least one data field that references the first document.

17. The computer program product of claim 16, wherein the readable textual format of the first data packet is stored as at least one of a detailed file or a summary file, wherein the at least one of the detailed file or the summary file references the first document sub-folder.

18. The computer program product of claim 17, wherein the at least one of the detailed file or the summary file comprises a hyperlink to the first document stored in the first document sub-folder.

19. The computer program product of claim 15, wherein the first document sub-folder is stored within a folder associated with the first identification record.

20. The computer program product of claim 15, wherein determining the file path of the first document is based on an API endpoint from which the first document is received.
